(19) United States
(12) Patent Application Publication
(10) Pub. No.: US 2026/0276834 A1
(43) Pub. Date: Sep. 17, 2026

(54) OBSERVATION APPARATUS AND ATMOSPHERIC STATE DETERMINATION METHOD

(71) Applicants: STANLEY ELECTRIC CO., LTD., Tokyo (JP); NATIONAL UNIVERSITY CORPORATION CHIBA UNIVERSITY, Chiba-shi (JP)

(72) Inventors: Yasuyuki KAWAKAMI, Tokyo (JP); Takumi IKEDA, Tokyo (JP); Tatsuo SHIINA, Chiba-shi (JP)

(73) Assignees: STANLEY ELECTRIC CO., LTD., Tokyo (JP); NATIONAL UNIVERSITY CORPORATION CHIBA UNIVERSITY, Chiba-shi (JP)

(21) Appl. No.: 19/561,903

(22) Filed: Mar. 10, 2026

(30) Foreign Application Priority Data
Mar. 11, 2025 (JP) 2025-038300

(51) Int. Cl. G01S 17/95; G01S 7/481; G01S 7/4865

(52) U.S. Cl. CPC G01S 17/95; G01S 7/4814; G01S 7/4865

(57) ABSTRACT

An observation apparatus and an atmospheric state determination method capable of determining an atmospheric state are provided. An observation apparatus includes a deep ultraviolet light source that transmits pulse light having a wavelength belonging to an ultraviolet region of a solar blind band, a photodetector that outputs a pulse of which a wave height changes according to the number of photons of reflected light of the pulse light received within a response period, and a wave height determinator, a wave height detection unit, a time of flight measurement unit, a data recording unit, a LiDAR data generator, a pulse number integration unit, a threshold distribution generation unit, and an atmospheric state determination unit. The wave height determinator determines and outputs a pulse having a wave height equal to or larger than a noise determination threshold among pulses output by the photodetector.

### CROSS-REFERENCE TO RELATED APPLICATION

This application is based upon and claims the benefit of priority from Japanese patent application No. 2025-038300, filed on Mar. 11, 2025, the disclosure of which is incorporated herein in its entirety by reference.

### BACKGROUND

The present disclosure relates to an observation apparatus capable of determining an atmospheric state, and an atmospheric state determination method.

International Patent Publication No. WO2003/073127 discloses an observation apparatus that performs LiDAR observation on the basis of observation light with respect to laser light emitted toward an observation target object.

On the other hand, the present inventors have found that a specific photodetector has a characteristic of outputting a pulse (voltage pulse signal) of which a wave height changes according to the number of photons of reflected pulse light received within a response period (or an interval less than the resolution of the photodetector) while conducting research and development of a LiDAR observation apparatus using a deep ultraviolet light source. On the basis of this new finding, an observation apparatus and an atmospheric state determination method for determining an atmospheric state by using a photodetector exhibiting this characteristic have been completed.

### SUMMARY

However, International Patent Publication No. WO 2003/073127 does not propose at all outputting a pulse of which a wave height changes according to the number of photons of reflected pulse light received within a response period (or an interval less than the resolution of a photodetector) or determining an atmospheric state by using a photodetector exhibiting this characteristic.

The present disclosure has been made to solve such a problem, and an object thereof is to provide an observation apparatus and an atmospheric state determination method capable of determining an atmospheric state.

According to the present disclosure, there is provided an observation apparatus including a deep ultraviolet light source configured to transmit pulse light having a wavelength belonging to an ultraviolet region of a solar blind band; a photodetector configured to output a pulse of which a wave height changes according to the number of photons of reflected light of the pulse light received within a response period; and a wave height determinator, a wave height detection unit, a time-of-flight measurement unit, a data recording unit, a LiDAR data generation unit, a pulse number integration unit, a threshold distribution generation unit, and an atmospheric state determination unit, in which the wave height determinator determines and outputs a pulse having a wave height equal to or more than a noise determination threshold among pulses output from the photodetector, the wave height detection unit detects the wave height of the pulse output from the photodetector every time the photodetector outputs the pulse, the time-of-flight measurement unit measures a time of flight every time the wave height determinator outputs the pulse, the data recording unit records the wave height and the time of flight in association with each other for each pulse output from the wave height determinator, the LiDAR data generation unit generates LiDAR data in which the number of pulses having a wave height equal to or more than the pulse determination threshold is aggregated for each distance for each of different pulse determination thresholds after end of the measurement period on the basis of the wave height and the time of flight recorded for each pulse output from the wave height determinator, the pulse number integration unit integrates a total number of pulses within a predetermined distance range in the LiDAR data for each piece of the LiDAR data, the threshold distribution generation unit generates a threshold distribution obtained by aggregating, for each threshold, the total number of pulses integrated for each piece of the LiDAR data, and the atmospheric state determination unit determines an atmospheric state by comparing the threshold distribution with a reference threshold distribution.

With such a configuration, it is possible to provide an observation apparatus capable of determining an atmospheric state.

In the observation apparatus, the atmospheric state determination unit may determine whether the atmospheric state is fine weather, rainy weather, or foggy weather.

According to the present disclosure, there is provided an atmospheric state determination method executed by an observation apparatus including a deep ultraviolet light source configured to transmit pulse light having a wavelength belonging to an ultraviolet region of a solar blind band and a photodetector configured to output a pulse of which a wave height changes according to the number of photons of reflected light of the pulse light received within a response period, the method including a wave height determination step of determining and outputting a pulse having a wave height equal to or more than a noise determination threshold among pulses output from the photodetector; a wave height detection step of detecting the wave height of the pulse output from the photodetector every time the photodetector outputs the pulse; a time of flight measurement step of measuring a time of flight every time a wave height determinator outputs the pulse; a data recording step of recording the wave height and the time of flight in association with each other for each pulse output from the wave height determinator; a LiDAR data generation step of generating LiDAR data in which the number of pulses having a wave height equal to or more than the pulse determination threshold is aggregated for each distance for each of different pulse determination thresholds after end of the measurement period on the basis of the wave height and the time of flight recorded for each pulse output from the wave height determinator; a pulse number integration step of integrating a total number of pulses within a predetermined distance range in the LiDAR data for each piece of the LiDAR data; a threshold distribution generation step of generating a threshold distribution obtained by aggregating, for each threshold, the total number of pulses integrated for each piece of the LiDAR data; and an atmospheric state determination step of determining an atmospheric state by comparing the threshold distribution with a reference threshold distribution.

With such a configuration, it is possible to provide an atmospheric state determination method capable of determining an atmospheric state.

According to the present disclosure, it is possible to provide an observation apparatus and an atmospheric state determination method capable of determining an atmospheric state.

The above and other objects, features and advantages of the present disclosure will become more fully understood from the detailed description given hereinbelow and the accompanying drawings.

### BRIEF DESCRIPTION OF DRAWINGS

FIG. 1 is a schematic configuration diagram of an observation apparatus;

FIG. 2 is a longitudinal sectional view (schematic view) of the observation apparatus shown in FIG. 1;

FIG. 3 is a graph showing a change pattern of a visual field coupling ratio in a case where a transmission light viewing angle is 10 mrad and a reception light viewing angle is 3 mrad;

FIG. 4 is an enlarged view of a portion at a distance of 0 to 30 m in FIG. 3;

FIG. 5 is a graph showing a change pattern of a visual field coupling ratio in a case where a transmission light viewing angle is 10 mrad and a reception light viewing angle is 5 mrad;

FIG. 6 is an enlarged view of a portion at a distance of 0 to 30 m in FIG. 5;

FIG. 7 is a conceptual diagram of observation data (LiDAR data) generation processing;

FIG. 8 is a schematic configuration diagram of an observation apparatus;

FIG. 9 is a graph showing an emission spectrum of a deep ultraviolet LED;

FIG. 10 is a diagram showing a state in which light (pulse light) emitted from the deep ultraviolet LED (light emitting surface) is also transmitted in a direction inclined with respect to an optical axis of a transmission unit;

FIG. 11 shows an example of a drive circuit;

FIG. 12A shows an example of transmission characteristics of pulse light;

FIG. 12B shows an example of transmission characteristics of pulse light;

FIG. 13 is a graph showing a relationship between a supply voltage (V) and a frequency (MHz);

FIG. 14 is a schematic diagram of a reception unit extracted from FIG. 8;

FIG. 15 is a schematic configuration diagram of an observation apparatus;

FIG. 16 is a cross-sectional view of a first reception mirror;

FIG. 17 is a cross-sectional view of a second reception mirror;

FIG. 18 shows a reflection spectrum of reflected light by each reception mirror;

FIG. 19 is a block diagram showing a main configuration of an observation apparatus;

FIG. 20 is an example of typical pulses and thresholds output from the photodetector;

FIG. 21A shows LiDAR data in a case where an observation target is fine weather;

FIG. 21B shows LiDAR data in a case where an observation target is foggy weather;

FIG. 21C shows LiDAR data in a case where an observation target is rainy weather;

FIG. 22 is an example in which the total number of pulses within a predetermined distance range (a distance range desired to be observed) of LiDAR data is integrated for each piece of LiDAR data;

FIG. 23A shows a threshold distribution in a case where an observation target is fine weather;

FIG. 23B shows a threshold distribution in a case where an observation target is foggy weather;

FIG. 23C shows a threshold distribution in a case where an observation target is rainy weather;

FIG. 24 is a flowchart of an operation example of an observation apparatus; and

FIG. 25 is a diagram showing a hardware configuration example of the observation apparatus according to the present disclosure.

### DESCRIPTION OF EMBODIMENTS

Hereinafter, an observation apparatus 10 according to an embodiment of the present disclosure will be described with reference to the accompanying drawings. In the drawings, corresponding components are denoted by the same reference numerals, and repeated descriptions are omitted.

### First Embodiment

### <Outline of Observation Apparatus 10>

First, an outline of the observation apparatus 10 according to the present embodiment will be described.

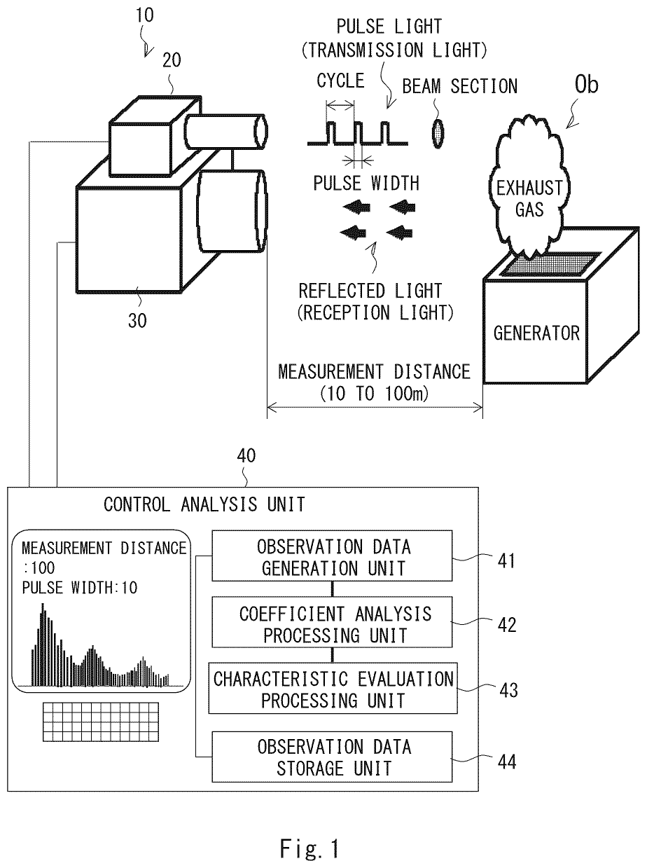

FIG. 1 is a schematic configuration diagram of the observation apparatus 10.

The observation apparatus 10 of the present embodiment is an apparatus (LiDAR apparatus) that remotely observes an observation target object Ob (for example, airborne particles such as aerosols and dust) existing at a short distance (for example, 10 to 150 m) in a non-contact manner.

As shown in FIG. 1, the observation apparatus 10 includes a transmission unit 20, a reception unit 30, and a control analysis unit 40.

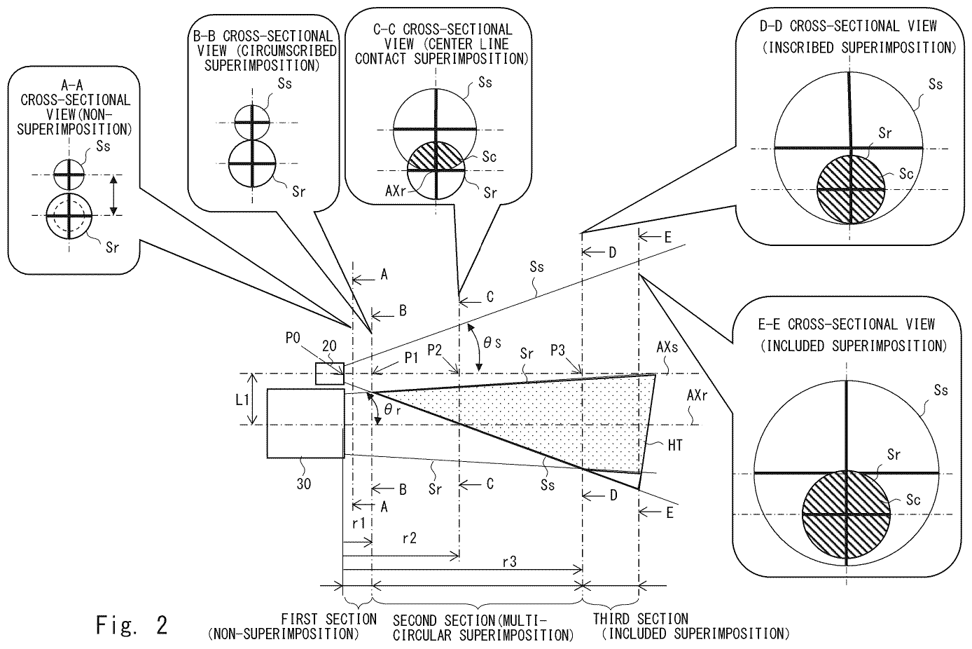

FIG. 2 is a longitudinal sectional view (schematic view) of the observation apparatus 10 shown in FIG. 1.

As shown in FIG. 2, the transmission unit 20 has a transmission light visual field Ss, and transmits pulse light (hereinafter, also referred to as transmission light) having a wavelength (for example, 265 nm) belonging to an ultraviolet region of the solar blind band within the transmission light visual field Ss. On the other hand, the reception unit 30 has a reception light visual field Sr, receives reflected light (reflected pulse light) reflected by the observation target object Ob and returning into the reception light visual field Sr among pieces of the transmission light (pulse light), and outputs a pulse electrical signal (electrical signal of a pulse wave) corresponding to the received reflected light. The pulse light may be spontaneous emission light (incoherence light).

An optical axis AXs of the transmission unit 20 and an optical axis AXr of the reception unit 30 are disposed in a state of being separated from each other and being parallel to each other. A distance L1 between the optical axis AXs of the transmission unit 20 and the optical axis AXr of the reception unit 30 is, for example, 85 mm.

The transmission light visual field Ss is a conical region centered on the optical axis AXs of the transmission unit 20 and having a diameter that increases as a distance from the transmission unit 20 increases along the optical axis AXs of the transmission unit 20. The minimum diameter (in FIG. 2, the diameter of the left end portion) of the transmission light visual field Ss is, for example, 60 mm. A transmission light viewing angle θs defining the transmission light visual field Ss is, for example, 10 mrad (0.57°).

On the other hand, the reception light visual field Sr is a conical region centered on the optical axis AXr of the reception unit 30 and having a diameter that increases as a distance from the reception unit 30 increases along the optical axis AXr of the reception unit 30. The minimum diameter (in FIG. 2, the diameter of the left end portion) of the reception light visual field Sr is, for example, 100 mm. A reception light viewing angle θr defining the reception light visual field Sr is, for example, 3 mrad (0.17°) or 5 mrad (0.29°).

As described above, the transmission light viewing angle θs is set to be larger than the reception light viewing angle θr.

Next, overlapping (superimposition) of the transmission light visual field Ss and the reception light visual field Sr will be described.

As described above, the optical axis AXs of the transmission unit 20 and the optical axis AXr of the reception unit 30 are disposed in a state of being separated from each other and parallel to each other, the transmission light visual field Ss and the reception light visual field Sr are each a conical region, and the transmission light viewing angle θs is set to be larger than the reception light viewing angle θr.

As a result, the transmission light visual field Ss and the reception light visual field Sr form a superimposed light visual field Sc by overlapping each other as shown in FIG. 2 (see a hatching region HT in FIG. 2 and the superimposed light visual field Sc in each cross-sectional view). Next, the superimposed light visual field Sc which is an overlap of the transmission light visual field Ss and the reception light visual field Sr will be specifically described.

The ratio of the superimposed light visual field Sc to the transmission light visual field Ss can be expressed by a visual field coupling ratio Crs. The visual field coupling ratio Crs is calculated by using the following Formula 1.

Visual field coupling ratio Crs=superimposed light visual field Sc/transmission light visual field Ss (Formula 1)

However, the superimposed light visual field Sc is an area of a region where the transmission light visual field Ss and the reception light visual field Sr overlap each other in each cross section (see each cross-sectional view in FIG. 2). The transmission light visual field Ss is an area of the transmission light visual field Ss in each cross section.

The large visual field coupling ratio Crs indicates that an amount of the reflected light (reflected pulse light) reflected by the observation target object Ob and returning to the reception light visual field Sr is large.

As shown in FIG. 2, the outer edge of the transmission light visual field Ss circumscribes the outer edge of the reception light visual field Sr at a first position P1 separated from a lens barrel distal end position P0 by a first distance r1 (see the cross-sectional view taken along line B-B in FIG. 2). In addition, the outer edge of the transmission light visual field Ss is in contact with the optical axis A Xr of the reception unit 30 at a second position P2 separated from the lens barrel distal end position P0 by a second distance r2 (see the cross-sectional view taken along line C-C in FIG. 2). In addition, the outer edge of the reception light visual field Sr is inscribed in the outer edge of the transmission light visual field Ss at a third position P3 separated from the lens barrel distal end position P0 by a third distance r3 (see the cross-sectional view taken along line D-D in FIG. 2). Further, at each position beyond the third position P3, the outer edge of the reception light visual field Sr is included in the outer edge of the transmission light visual field Ss without being in contact with the outer edge of the transmission light visual field Ss (see the cross-sectional view taken along line E-E in FIG. 2).

Next, a change pattern of the visual field coupling ratio Crs will be described.

First, a change pattern of the visual field coupling ratio Crs in a case where the transmission light viewing angle θs is 10 mrad and the reception light viewing angle θr is 3 mrad will be described.

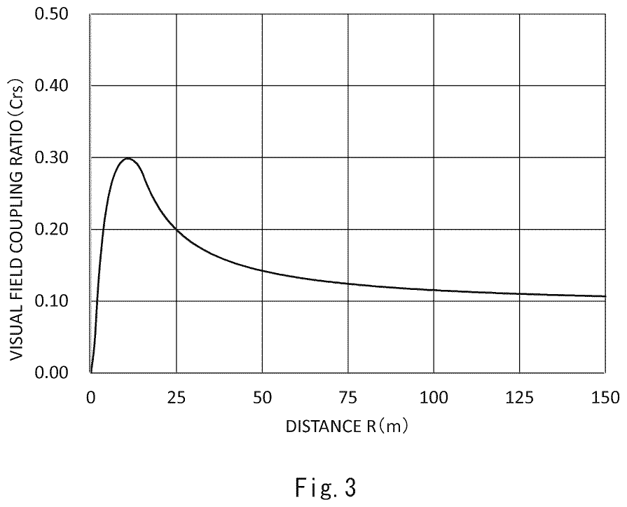

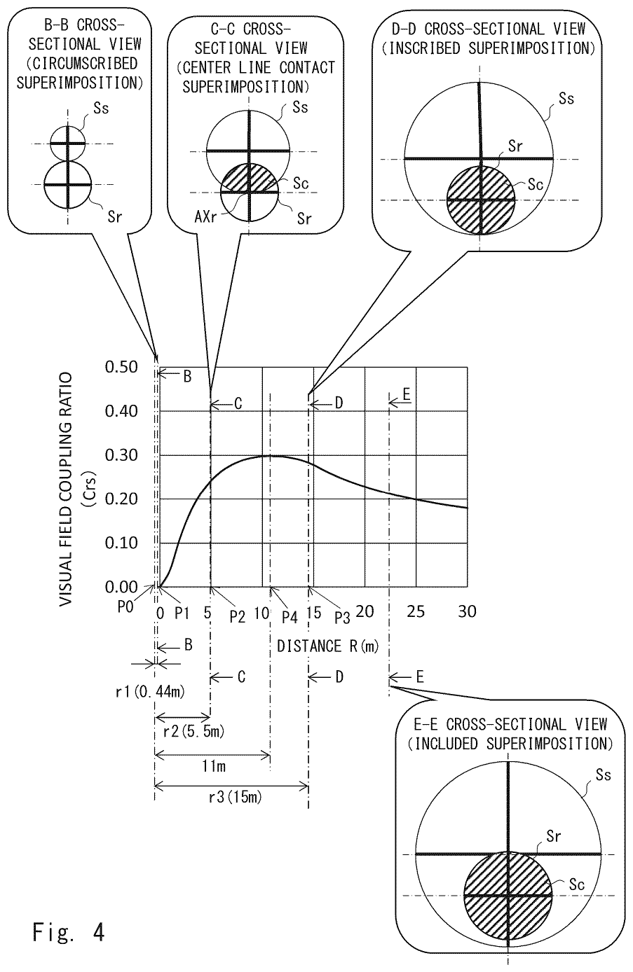

FIG. 3 is a graph showing a change pattern of the visual field coupling ratio Crs in a case where the transmission light viewing angle θs is 10 mrad and the reception light viewing angle θr is 3 mrad. FIG. 4 is an enlarged view of a portion at a distance of 0 to 30 m in FIG. 3.

As shown in FIG. 4, in a case where the transmission light viewing angle θs is 10 mrad and the reception light viewing angle θr is 3 mrad, the first position P1 is a position separated from the transmission unit 20 (lens barrel distal end position P0) by the first distance r1 (0.44 m) along the optical axis AXs of the transmission unit 20. The second position P2 is a position separated from the transmission unit 20 (lens barrel distal end position P0) by the second distance r2 (5.5 m) along the optical axis AXs of the transmission unit 20. The third position P3 is a position separated from the transmission unit 20 (lens barrel distal end position P0) by the third distance r3 (15 m) along the optical axis AXs of the transmission unit 20. In addition, the fourth position P4 is a position at which the visual field coupling ratio Crs is maximized and which is 11 m away from the transmission unit 20 (lens barrel distal end position P0) along the optical axis AXs of the transmission unit 20.

The distance region from the lens barrel distal end position P0 to the first position P1 is a region in which the outer circumference of the transmission light visual field Ss and the outer circumference of the reception light visual field Sr are separated from each other. Therefore, since the superimposed light visual field Sc is not formed, the visual field coupling ratio Crs is zero. Next, the distance region from the first position P1 to the second position P2 is a distance region from the point where the outer circumference of the transmission light visual field Ss is in contact with the outer circumference of the reception light visual field Sr to the optical axis A Xr of the reception light visual field Sr. In this region, the visual field coupling ratio Crs increases steeply in accordance with the enlargement of the superimposed light visual field Sc. Next, the distance region from the second position P2 to the third position P3 is a region in which the outer circumference of the transmission light visual field Ss exceeds the optical axis AXr of the reception light visual field Sr and reaches the outer circumference on the far side of the reception light visual field Sr. In this region, since the transmission light visual field Ss also enlarges while the superimposed light visual field Sc enlarges, the visual field coupling ratio Crs gradually increases to reach a maximum value and then decreases. Finally, the distance region beyond the third position P3 is a distance region in which the transmission light visual field Ss includes the reception light visual field Sr. In this region, the superimposed light visual field Sc and the reception light visual field Sr are equal to each other, but since the enlargement ratio of the transmission light visual field Ss is large, the visual field coupling ratio Crs gradually decreases.

Next, a change pattern of the visual field coupling ratio Crs in a case where the transmission light viewing angle θs is 10 mrad and the reception light viewing angle θr is 5 mrad will be described.

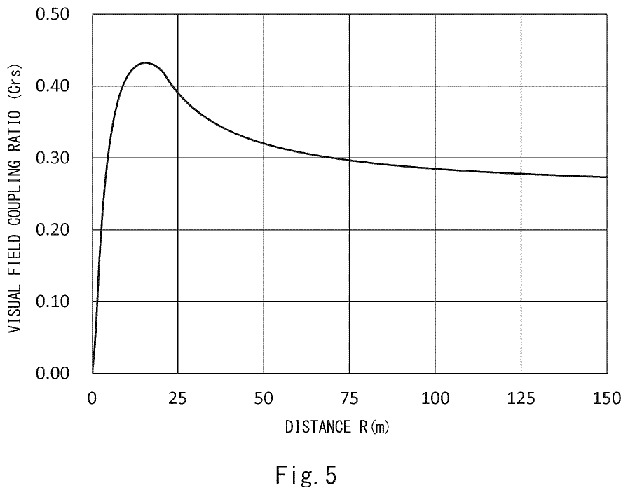

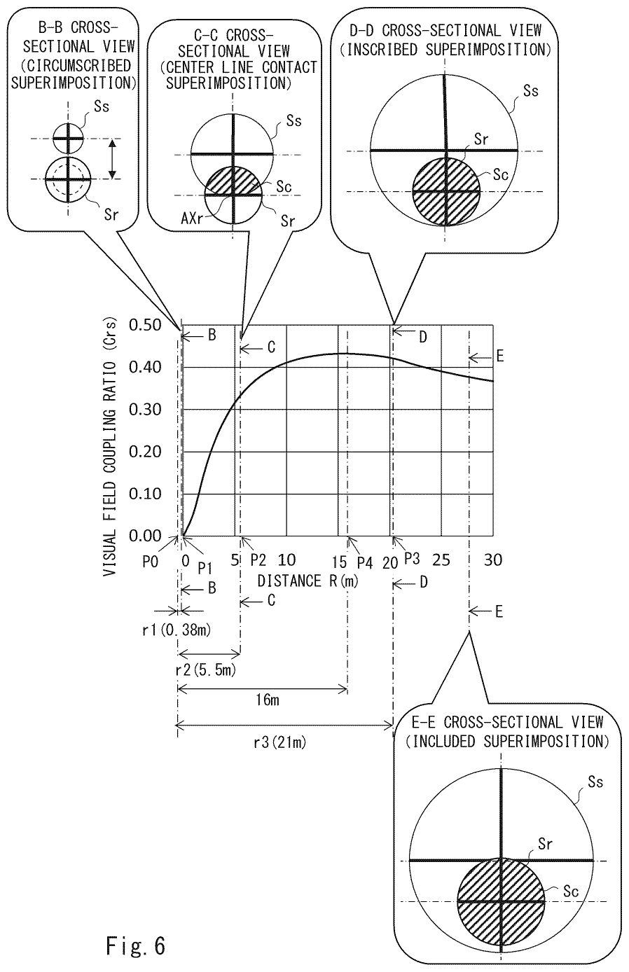

FIG. 5 is a graph showing a change pattern of the visual field coupling ratio Crs in a case where the transmission light viewing angle θs is 10 mrad and the reception light viewing angle θr is 5 mrad. FIG. 6 is an enlarged view of a portion at a distance of 0 to 30 m in FIG. 5.

As shown in FIG. 6, in a case where the transmission light viewing angle θs is 10 mrad and the reception light viewing angle θr is 5 mrad, the first position P1 is a position separated from the transmission unit 20 (lens barrel distal end position P0) by the first distance r1 (0.38 m) along the optical axis AXs of the transmission unit 20. The second position P2 is a position separated from the transmission unit 20 (lens barrel distal end position P0) by the second distance r2 (5.5 m) along the optical axis AXs of the transmission unit 20. The third position P3 is a position separated from the transmission unit 20 (lens barrel distal end position P0) by the third distance r3 (21 m) along the optical axis AXs of the transmission unit 20. In addition, the fourth position P4 is a position at which the visual field coupling ratio Crs is maximized and which is 16 m away from the transmission unit 20 (lens barrel distal end position P0) along the optical axis AXs of the transmission unit 20.

The change in the visual field coupling ratio Crs in each distance region from the lens barrel distal end position P0 to the first position P1, from the first position P1 to the second position P2, from the second position P2 to the third position P3, and beyond the third position P3 is similar to the case where the reception light viewing angle θr is 3 mrad. However, since the reception light viewing angle θr of the reception light visual field Sr is as large as 5 mrad, the visual field coupling ratio Crs at the same observation distance increases.

As described above, the observation can be performed from a distance beyond the first position P1 (circumscribed superimposition distance) where the superimposed light visual field Sc is formed. In addition, it is preferable that the observation is performed at a distance beyond the second position P2 at which the superimposed light visual field Sc is about half or more of the reception light visual field Sr (center line contact superimposition distance). Furthermore, in consideration of the missing portion of the superimposed light visual field Sc and the visual field coupling ratio Crs, the observation is preferably performed at a distance beyond the third position P3 at which the superimposed light visual field Sc coincides with the reception light visual field Sr (inscribed superimposition distance). Note that, since the transmission unit 20 and the reception unit 30 are separated in the observation apparatus 10, there is no influence due to light shielding by the transmission unit 20 in the distance region beyond the first position P1. In addition, the optical axis AXs of the transmission light visual field Ss and the optical axis AXr of the reception light visual field Sr are disposed to be separated from and parallel to each other in the observation apparatus 10, so that the superimposed light visual field Sc does not have a missing portion in the distance region beyond the third position P3.

Here, the distance r2 from the lens barrel distal end position P0 to the second position P2 depends only on the transmission light viewing angle θs regardless of the reception light viewing angle θr. In this case, the distance r1 from the lens barrel distal end position P0 to the first position P1 can be shortened by increasing the reception light viewing angle θr, and the distance r3 from the lens barrel distal end position P0 to the third position P3 can be shortened by decreasing the reception light viewing angle θr.

Hereinafter, the section between the lens barrel distal end position P0 and the first position P1 will be referred to as a first section. The section between the first position P1 and the second position P2 will be referred to as a second section. The section between the second position P2 and the third position P3 will be referred to as a third section. The geometric correction element affecting the reception light in the three sections is included in the geometric efficiency factor Y(R) of the LiDAR equation.

The LiDAR equation is generally expressed by the following equation.

$$P ( R ) = {P}_{0} Y ( R ) C \frac{β ( R )}{{R}^{2}} exp [ - 2 {\int }_{0}^{R} α ( r ) dr ] \qquad [ Math . 1 ]$$

Here, R is a distance, P is a reception light intensity, Po is a transmission light output, Y is a geometric efficiency factor, Cis a device constant, β is a backscattering coefficient, and α is a dissipation coefficient (absorption+diffusion). In addition, P(R), Y(R), β(R), and α(R) respectively represent an intensity, a factor, and coefficients at the distance R. In addition, r is an elapsed distance up to the distance R. Each coefficient depends on a substance (particles floating in the air) constituting the observation target object Ob. Furthermore, in the description of the three sections, it is assumed that the observation target object Ob is uniformly distributed in the entire space in the depth direction from the lens barrel distal end position P0 to the observation limit distance (a maximum observation distance that will be described later) and in the plane direction of the transmission light visual field Ss and the reception light visual field Sr. That is, the three sections are inner spaces of the observation target object Ob.

In the first section, the transmission light visual field Ss and the reception light visual field Sr do not overlap each other. Therefore, in the first section, there is almost no reflected light (reflected pulse light) reflected by the observation target object Ob and returning into the reception light visual field Sr. That is, the first section is an unobservable section.

In the second section, since the visual field coupling ratio Crs increases or decreases, the amount of the reflected light (reflected pulse light) reflected by the observation target object Ob and returning into the reception light visual field Sr also increases or decreases. Specifically, the change in the visual field coupling ratio Crs is caused by a correlation between an increase in the overlapping ratio of the transmission light visual field Ss to the reception light visual field Sr and a relative decrease in the superimposed light visual field Sc according to the enlargement ratios (viewing angles θs and θr) of the transmission light visual field Ss and the reception light visual field Sr. Therefore, the amount of the reflected light (reflected pulse light) in the second section increases as the distance R increases, reaches the maximum value, and then decreases. That is, the second section is an observation transition section.

In the third section, since the visual field coupling ratio Crs decreases according to the enlargement ratios (viewing angles θs and θr) of the transmission light visual field Ss and the reception light visual field Sr, the reflected light (reflected pulse light) reflected by the observation target object Ob and returning into the reception light visual field Sr also decreases. That is, the third section is an observation stable section.

Since the transmission light visual field Ss and the reception light visual field Sr overlap each other as described above, it is possible to receive reflected light (reflected pulse light) reflected by the observation target object Ob and returning into the reception light visual field Sr. That is, the reception light intensities P(R) in the second section and the third section in which the reflected light (reflected pulse light) is obtained are corrected by the geometric efficiency factor Y(R) in Formula 1 on the basis of the visual field coupling ratio Crs. Therefore, the short distance measurement can be performed without being affected by the change in the superimposed light visual field Sc. As a result, the observation target object Ob existing at a short distance (beyond the first position P1) can be observed. That is, observation data (LiDAR data) of the observation target object Ob existing at a short distance (beyond the first position P1) can be generated with high accuracy.

In particular, the transmission light viewing angle θs is set to be larger than the reception light viewing angle θr (see FIG. 2). As a result, the distance from the lens barrel distal end position P0 to the first position P1 (first section) can be shortened, and the distance from the second position P2 to the third position P3 (second section) can also be shortened. The section distance from the third position P3 and beyond (third section) to the maximum observation distance (a distance defined by the pulse light interval of the transmission light) can be lengthened. In addition, in the second section and third section in which observation can be performed, when the reception light viewing angle θr is large, the visual field coupling ratio Crs can be increased, so that the reception light intensity P(R) can be increased.

On the other hand, when the reception light viewing angle θr is small, the resolution of the optical axis orthogonal plane is improved, and when the reception light viewing angle θr is large, the resolution of the optical axis orthogonal plane deteriorates. In addition, when the reception light viewing angle θr is small, the third distance r3 (see FIG. 2) becomes short, and when the reception light viewing angle θr is large, the third distance r3 becomes long.

From the above description, in a case where a short distance is observed with high resolution, the reception light viewing angle θr is preferably small (for example, 3 mrad). On the other hand, in the case of observing the reception light intensity P(R) from a distant place, the reception light viewing angle θr is preferably larger (for example, 5 mrad).

In addition, in a case where the observation target object Ob is a non-light shielding body such as aerosol, dust, fog, rainfall, or snowfall in the form of a screen (in a state of being thin in the distance direction), another observation target object in front of or behind the observation target object Ob can also be observed in the second section and the third section.

Since the reception light visual field Sr is included in the transmission light visual field Ss beyond the third position P3 (third section), a plurality of observation target objects Ob partially present in the reception light visual field Sr can be observed (measured). In a case where the transmission light is a linear beam (for example, laser light), LiDAR data of the observation target object Ob other than the observation target object Ob at the position where the transmission light is transmitted cannot be obtained.

Next, observation data (LiDAR data) generation processing will be described.

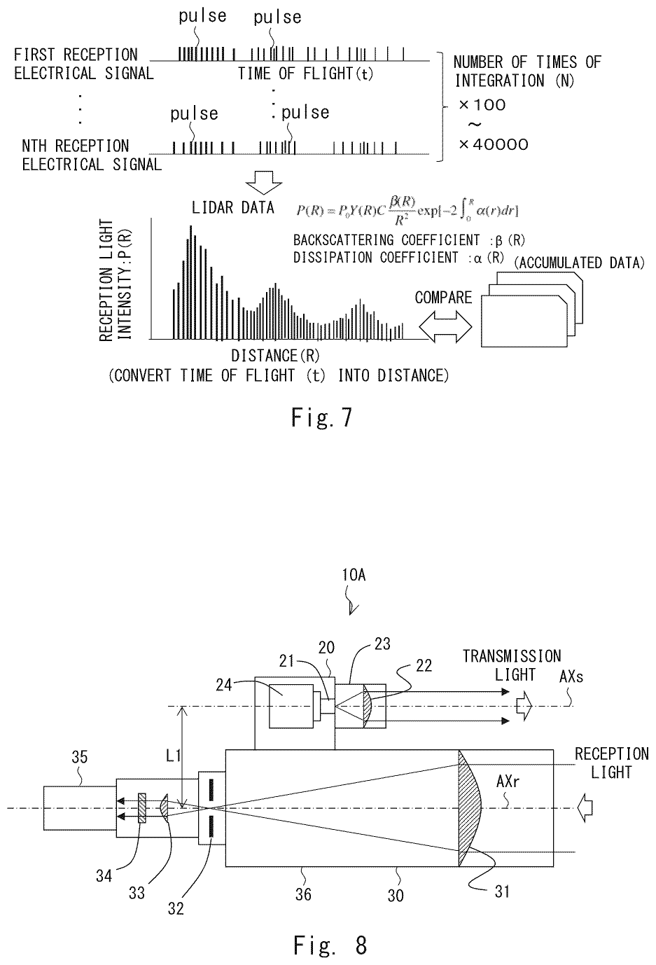

FIG. 7 is a conceptual diagram of observation data (LiDAR data) generation processing.

The observation data (LiDAR data) generation processing is executed by the control analysis unit 40. The control analysis unit 40 may be a dedicated device in which a device that will be described later for generating and processing observation data for the observation apparatus 10 is housed in a casing, or may be a composite device including another observation device such as an observation camera.

As shown in FIG. 1, the control analysis unit 40 includes an observation data generation unit 41, a coefficient analysis processing unit 42, a characteristic evaluation processing unit 43, and an observation data storage unit 44.

The observation data generation unit 41 divides a pulse electrical signal output by the reception unit 30 in response to the reflected light (reflected light (reflected pulse light; specifically, photons) that is reflected by the observation target object Ob and returns to the reception light visual field Sr) for each reception cycle by using a photon counting circuit (a circuit that performs photon counting), and integrates the electrical signals N times to generate observation data (LiDAR data). In FIG. 7, the lowermost graph is an example of observation data (LiDAR data). The generated observation data (LiDAR data) is stored (accumulated) in the observation data storage unit 44.

In FIG. 7, the first reception electrical signal to the Nth reception electrical signal represent pulse electrical signals divided for each reception cycle. In FIG. 7, each pulse pulse described in the graph on the right side of the first reception electrical signal represents a pulse electrical signal output according to reflected light (reflected light (reflected pulse light; and specifically photons) reflected by the observation target object Ob and returning into the reception light visual field Sr) received by the reception unit 30 during the reception cycle in a case where the first pulse light (transmission light) is transmitted. The same applies to each pulse pulse described in the graph on the right side of the Nth reception electrical signal.

The time of flight (t) of the first reception electrical signal represents the time of flight (round-trip time of flight) of the photons corresponding to each pulse pulse to and from the observation target object Ob. In the graph of the Nth reception electrical signal, the time of flight (t) is omitted.

Note that the present disclosure is not limited to the photon counting circuit, and any circuit may be used as long as the circuit executes photon counting. For example, a digital oscilloscope and a PC (an information processing apparatus such as a personal computer) may be used in combination.

The coefficient analysis processing unit 42 executes processing of calculating a spatial distribution (distance direction) of the observation target object Ob from an increase/decrease change in observation data (LiDAR data), evaluating the observation data (LiDAR data) with a LiDAR equation, and calculating the dissipation coefficient α and the backscattering coefficient β specific to the observation target object Ob.

For example, when the observation target object Ob is uniform atmosphere in the space from the lens barrel distal end position P0 to the maximum observation distance (Rmax), the reception light intensity P(R) indicates a change that increases according to the distance (R) and the geometric efficiency factor Y(R) and attenuates after reaching the maximum value. In addition, when the observation target object Ob is spatially uniform, the dissipation coefficient α(R) and the backscattering coefficient β(R) may be α and β because there is no change due to the distance. Therefore, since the LiDAR equation is Ln((P(R)R²)/Y(R))=−2αR+ln P₀Cβ), the dissipation coefficient α can be obtained from the slope term −2αR, and the backscattering coefficient β can be obtained from the intercept term ln(P₀Cβ).

The characteristic evaluation processing unit 43 executes, for example, atmospheric evaluation at a fixed point and evaluation of smoke, dust, and the like.

For example, the atmospheric evaluation at a fixed point can be performed by periodically observing the atmosphere every year and evaluating the atmosphere by using backscattering coefficient β and dissipation coefficient α of fine particles such as aerosols contained in the observed atmosphere. In addition, the transition of the atmospheric state can be evaluated through comparison with observation values of the reference year. In this case, comparison with the disclosed standard atmosphere may be performed to estimate, for example, the type of fine particles floating in the space (see ex. Laser Radar Society of Japan, 4 (2020), Kuze, Measurement of Light Scattering of Aerosols and Atmospheric Molecules). The evaluation of fog, rain, and snow may also be performed in the same manner as the atmospheric evaluation at a fixed point.

Evaluation of smoke and dust, for example, evaluation of cleanliness of device exhaust, exhaust smoke from a chimney, on-road dust, and the like may be performed by comparing characteristics of the atmosphere other than the exhaust portion with characteristics of the atmosphere of the exhaust portion.

The observation data storage unit 44 is a nonvolatile storage unit such as a hard disk device or an SSD that stores the observation data (LiDAR data) generated by the observation data generation unit 41.

Since the control analysis unit 40 (observation data generation unit 41) has a function (known direct time of flight (dToF) method, photon counting, and the like) of measuring (calculating) the time of flight of the reflected light (photons) received by the reception unit 30 to the observation target object Ob, it is possible to measure (calculate) the time of flight (round-trip time of flight) of the photons corresponding to each pulse pulse to the observation target object Ob.

The observation data (LiDAR data) is generated by integrating (N-time integration) the first reception electrical signal to the Nth reception electrical signal. In the graph shown in the lowermost part of FIG. 7, the vertical axis represents a reception light intensity and corresponds to the number of photons. The horizontal axis represents a distance. This distance is obtained by converting the time of flight (t) into a distance.

Next, improvement in short distance observability, downsizing, and observation convenience by the observation apparatus 10 will be described. The short distance described herein is a distance of about several meters to several hundred meters.

### (Short Distance Observability)

The observation apparatus 10 can increase a transmission frequency of the transmission light (pulse light) transmitted from the transmission unit 20 from 1 megahertz (MHz) to about 10 MHz. For example, in a case where the observation target object Ob locally exists within a distance of about 50 m to 100 m, the maximum observation distance (Rmax) can be set to 150 m. The maximum observation distance is a distance defined by a transmission cycle of transmission light (pulse light). For example, in a case where the transmission cycle of the transmission light (pulse light) is 1 microsecond (μsec), the flight distance of the transmission light is 300 m. That is, the maximum observation distance (Rmax) is 150 m which is a distance at which the previously transmitted transmission light does not interfere with the next transmission light. The transmission frequency in this case is 1 MHz. Similarly, when the maximum observation distance (Rmax) is 15 m, the transmission cycle of the transmission light (pulse light) is 0.1 usec and the transmission frequency is 10 MHz.

The LiDAR data is generated by integrating each pulse pulse of one unit cycle incident on the reception unit 30 a plurality of times. Therefore, the LiDAR data can be generated in a short time by increasing the transmission frequency of the transmission light (pulse light). In particular, since the apparent moving speed (moving angle per unit time) of the observation target object Ob at a short distance is large, short-time observation is important to improve a spatial resolution. For example, when the distance to the observation target object Ob is 100 m and the number of times of integration of the LiDAR data is 1000, if the transmission frequency is 1 MHz (transmission cycle 1 μsec), one observation time is 1 millisecond (msec). In this case, if the observation target object Ob moves at a wind speed of 3 m/s (a wind speed of about the breeze), the observation target object Ob moves by 3 mm between the start and the end of the observation. That is, the moving angle is 0.0017°. Therefore, the reception light viewing angle ratio (moving angle/reception light viewing angle θr) is 0.01 (1%) when the reception light viewing angle θr is 3 mrad (0.17°), and is 0.006 (0.6%) when the reception light viewing angle θr is 5 mrad (0.29°). When the distance to the observation target object Ob is 50 m, the moving angle is 0.0034°. Therefore, the reception light viewing angle ratio is 0.02 (2%) when the reception light viewing angle θr is 3 mrad, and is 0.012 (1.2%) when the reception light viewing angle θr is 5 mrad. As described above, by increasing the transmission frequency, even in a case where the observation target object Ob at a short distance is moving, it is possible to observe the observation target object Ob with high accuracy.

In addition, the observation apparatus 10 reduces the pulse width of the transmission light (pulse light) transmitted from the transmission unit 20 to about 1 nanosec (nsec). For example, the distance resolution is 1.5 m when the pulse width is 10 nsec, and the distance resolution is 0.15 m when the pulse width is 1 nsec. As described above, by narrowing the transmission light, the observation target object Ob can be observed with high accuracy in the short distance measurement.

The observation apparatus 10 sets the wavelength of the transmission light (pulse light) transmitted from the transmission unit 20 to a solar blind wavelength in a deep ultraviolet light band without atmospheric absorption (absorption by oxygen and nitrogen). Here, the solar blind wavelength in the deep ultraviolet light band is a deep ultraviolet wavelength band that significantly attenuates before reaching the ground surface among pieces of sunlight reaching the earth. Specifically, the solar blind wavelength is a wavelength on the longer wavelength side than the wavelength near the long-wavelength absorption edge of the absorption wavelengths of oxygen and nitrogen and on the shorter wavelength side than the long-wavelength absorption edge of the absorption wavelength of the ozone layer. Specifically, the solar blind wavelength is 230 nanometers (nm) or more and 300 nm or less. The solar blind wavelength is preferably 250 nm to 280 nm. With such a wavelength band, it is possible to perform observation with a low-output light source because there is no influence of external light and no influence of absorption of the atmosphere.

In addition, by setting the wavelength of the transmission light (pulse light) to the solar blind wavelength in the deep ultraviolet light band without atmospheric absorption, the backscattering coefficient β and the dissipation coefficient α of the fine particles contained in the observation target object Ob become larger than those of near-ultraviolet to infrared light. As a result, even when the thickness of the observation target object Ob in the distance direction is small, or even when the concentration of contained particles is low, observation can be performed. Specifically, the dissipation coefficient α increases in inverse proportion to the 1.25 power of the wavelength, and becomes about five times by shortening the wavelength from 900 nm to 265 nm. Since the backscattering coefficient β is approximately proportional to the dissipation coefficient α, the backscattering coefficient β similarly increases by about a factor of five. That is, it is possible to perform highly sensitive observation even at a short distance (a short passing distance of the observation target object Ob). In addition, the features of the observation target object Ob (for example, aerosol, smoke, dust, fog, rain, or snow) can be easily identified.

### (Downsizing)

The observation apparatus 10 uses a deep ultraviolet light emission diode (LED) which is a semiconductor light emitting element that emits deep ultraviolet light (for example, the wavelength thereof is 265 nm). The deep ultraviolet LED has a size of about 1 mm². In addition, the deep ultraviolet LED can also downsize a light transmission circuit that emits light having a high frequency and a narrow pulse width. In addition, a small lens having a small aperture (aperture φ of about 60 mm) can configure a collimated transmission system having a high light flux utilization ratio. Therefore, the transmission unit 20 can be downsized.

The observation apparatus 10 uses a photomultiplier tube (PMT) for ultraviolet rays corresponding to photon counting as a light receiving element. Therefore, the PMT is small. In addition, since the transmission light of the transmission unit 20 has a solar blind wavelength in a deep ultraviolet light band without atmospheric absorption, the main concentrator of the reception unit 30 can be a small lens or a reflecting mirror (aperture φ of about 100 mm). Therefore, the reception unit 30 can be downsized.

### (Observation Convenience)

The observation apparatus 10 enables observation to be performed regardless of day or night by using a semiconductor light emitting element (for example, an LED having a wavelength of 265 nm) that emits ultraviolet band light in a solar blind band without atmospheric absorption as a light source of the transmission unit 20. For example, it is possible to perform observation under fine weather in the daytime and observation under illumination such as a fluorescent lamp or a halogen lamp at night. As a result, it is possible to perform observation at regular intervals over day and night. In addition, since illumination can be projected to the observation target object Ob even at night, aiming at the observation target object Ob becomes easy.

### <First Configuration Example of Observation Apparatus 10>

Next, a specific first configuration example of the observation apparatus 10 will be described. Hereinafter, the observation apparatus of the first configuration example will be referred to as an observation apparatus 10A.

FIG. 8 is a schematic configuration diagram of the observation apparatus 10A.

The observation apparatus 10A is an observation apparatus (LiDAR apparatus) including a transmission unit 20 and a reception unit 30 of a refractive optical system.

As shown in FIG. 8, the observation apparatus 10A includes a transmission unit 20, a reception unit 30, and a control analysis unit 40 (not shown in FIG. 8). The optical axis AXs of the transmission unit 20 and the optical axis AXr of the reception unit 30 are disposed to be separated from and parallel to each other.

### <Transmission Unit 20>

The transmission unit 20 includes a semiconductor light emitting element 21 and a transmission lens 22 (an example of a transmission optical system of the present disclosure). In FIG. 8, the reference numeral 23 denotes a transmission lens barrel, and the reference numeral 24 denotes a drive circuit of the semiconductor light emitting element 21.

The semiconductor light emitting element 21 is a semiconductor light emitting element which has an excellent response speed (for example, high frequency and short pulse light can be emitted) and emits light (pulse light) having a wavelength belonging to the ultraviolet region of the solar blind band, and is, for example, a deep ultraviolet LED. Hereinafter, the semiconductor light emitting element 21 will also be referred to as a deep ultraviolet LED 21.

Hereinafter, an example in which a deep ultraviolet LED having a Lambertian light distribution (distribution) having a peak wavelength (center wavelength) of 265 nm and a half value angle of about 120° is used as the semiconductor light emitting element 21 will be described. Hereinafter, the semiconductor light emitting element 21 will also be referred to as a deep ultraviolet LED 21.

Specifications of the deep ultraviolet LED 21 are as described in the following table.

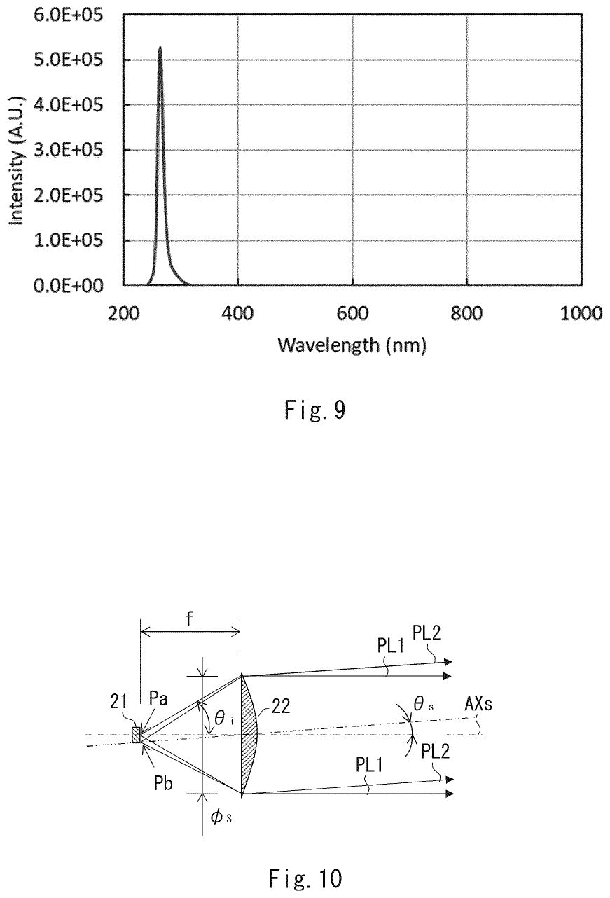

TABLE 1

| | |
|---|---|
| Spectrum (see FIG. 9) | λp = 265 nm (full width at half |
| | maximum = 12 nm) |
| Directional characteristic | Lambertian (half value angle 120°) |
| Light output | Continuous power 50 mW@3 W |
| | 1 mW to 500 mW at pulse output |
| Responsiveness | 1 ns |

The spectrum of the employed deep ultraviolet LED without atmospheric absorption is a peak wavelength (λp) of 265 nm and a full width at half maximum (fWHM) of 12 nm. The directional characteristic is Lambertian with a half-value angle of 120°. The light output is 50 mW at 3 W input power under continuous power (cw) conditions and 1 mW to 500 mW at pulse output. The responsiveness is 1 ns or more.

The deep ultraviolet LED 21 used for the transmission unit 20 of the observation apparatus 10A is sealed in a CAN package. The CAN package is mounted on a heat sink included in the drive circuit 24. A portion other than the light emission port of the CAN package is covered with a partition plate made of a material that absorbs stray light emitted from the deep ultraviolet LED. In addition to the CAN package, the deep ultraviolet LED may be mounted on a ceramic substrate such as aluminum oxide, silicon nitride, or aluminum nitride that has high thermal conductivity (for example, 30 to 200 W/m·K) and absorbs stray light. Further, the deep ultraviolet LED may be mounted on a ceramic inlay type glass epoxy substrate in which a ceramic is fitted in a portion where the deep ultraviolet LED is mounted. It is preferable to provide a heat sink on the back surface side (the surface opposite to the surface on which the deep ultraviolet LED is mounted) of the ceramic substrate or the ceramic inlay type glass epoxy substrate.

The deep ultraviolet LED 21 has a light emitting surface of 1.04 mm square. The light (pulse light) emitted from the deep ultraviolet LED is incoherent light or incoherence light (which is divergent light having a random phase and a wide full width at half maximum). The light (pulse light) emitted from the deep ultraviolet LED 21 is isotropic light (light having no polarization).

The transmission lens 22 is, for example, a condensing lens that is rotationally symmetric with respect to the optical axis AXs of the transmission unit 20. The transmission lens 22 is made of quartz glass that transmits the light emitted from the deep ultraviolet LED 21. The transmission lens 22 may be made of borosilicate glass, silicate glass, amorphous fluororesin, or the like that transmits deep ultraviolet light.

Specifications of the transmission lens 22 are as described in the following table.

TABLE 2

| Lens diameter φs | 60 mm |
|---|---|
| Transmission light viewing angle θs | 0.573° (10 mrad) |
| Focal length f | 52 mm |
| Uptake angle θi | 30° |

When an uptake angle θi (see FIG. 10) of the transmission lens 22 is 30° and the diameter φs (see FIG. 10) of the transmission lens 22 is 60 mm, the focal length f (see FIG. 10) is 52 mm. This can be calculated from the equation tan(θi)=(φs/2)/f. On the other hand, when the size Es of the deep ultraviolet LED 21 (light emitting surface) is 1.04 mm square, the transmission light viewing angle θs is about 10 mrad. This can be calculated from the equation of tan θs=(Es/2)/f.

The optical axis of the transmission lens 22 and the optical axis of the deep ultraviolet LED 21 (light emitting surface) coincide (substantially coincide) with the optical axis AXs of the transmission unit 20. The optical axis of the deep ultraviolet LED 21 (light emitting surface) passes through the center of the light emitting surface and extends in a direction perpendicular to the light emitting surface.

The focal point of the transmission lens 22 is disposed near the center of the deep ultraviolet LED 21 (light emitting surface). Therefore, light (pulse light) emitted from the deep ultraviolet LED 21 is collimated by the transmission lens 22. As a result, transmission light suitable for observation at a short distance (for example, 15 m to 150 m) can be obtained.

The beam diameter (aperture) of the transmission light is sufficiently larger than the observation target object Ob in order to stably observe (measure) the observation target object Ob (for example, particulates (aerosols) in the atmosphere). For example, the beam diameter (aperture) of the transmission light is 60 mm in diameter.

As described above, by using the condensing lens (collimating lens) as the transmission lens 22, the light (pulse light) emitted from the deep ultraviolet LED 21 can be formed into collimated light having a diameter equal to the lens diameter (60 mm) of the transmission lens 22.

On the other hand, the deep ultraviolet LED 21 (light emitting surface) is not a point light source but has a constant size. Therefore, the light (pulse light) emitted from the deep ultraviolet LED 21 (light emitting surface) is also transmitted in a direction inclined with respect to the optical axis AXs of the transmission unit 20.

FIG. 10 is a diagram showing a state in which pieces of light PL1 and PL2 (pulse light) emitted from the deep ultraviolet LED 21 (light emitting surface) are also transmitted in a direction inclined with respect to the optical axis AXs of the transmission unit 20.

As shown in FIG. 10, the light PL1 emitted from a center Pa of the deep ultraviolet LED 21 (light emitting surface) is refracted (collimated) by the transmission lens 22 and transmitted in the direction of the optical axis AXs of the transmission unit 20. On the other hand, the light PL2 emitted from a position Pb shifted downward with respect to the center of the deep ultraviolet LED 21 (light emitting surface) is refracted by the transmission lens 22 and transmitted in a direction inclined upward by a predetermined angle with respect to the optical axis AXs of the transmission unit 20. Similarly, although not shown, light emitted from a position shifted upward with respect to the center of the deep ultraviolet LED 21 (light emitting surface) is refracted by the transmission lens 22 and transmitted in a direction inclined downward by a predetermined angle with respect to the optical axis AXs of the transmission unit 20. The same applies to light emitted from other positions of the deep ultraviolet LED 21 (light emitting surface).

As a result, the transmission light visual field Ss becomes a conical region of which the diameter increases as a distance from the transmission unit 20 (lens barrel distal end position P0) increases along the optical axis AXs of the transmission unit 20 with the optical axis AXs of the transmission unit 20 as the center (see FIG. 2).

The transmission light visual field Ss (transmission light viewing angle θs) can be adjusted by changing the focal length f. For example, in a case where the uptake angle θi is constant, the transmission light viewing angle θs can be made wider than that before the focal length f is shortened by shortening the focal length f. In this case, the lens diameter φs of the transmission lens 22 decreases. Conversely, the transmission light viewing angle θs can be made narrower than that before the focal length f is increased by increasing the focal length f. In this case, the lens diameter φs of the transmission lens 22 increases. Thus, the transmission light viewing angle θs can be easily adjusted by using the deep ultraviolet LED 21 having the Lambertian directional characteristic and the transmission lens 22. That is, the transmission light visual field Ss can be easily made larger than the reception light visual field Sr.

The transmission lens barrel 23 is made of aluminum (Al), and the inner cylinder surface is subjected to antireflection treatment of a black alumite film that prevents (absorbs) reflection of emitted light (stray light) of the deep ultraviolet LED 21. The transmission lens barrel 23 may be made of a corrosion-resistant metal material such as stainless steel or invar, a resin material such as polycarbonate, acrylic, polypropylene, polyethylene, or epoxy, or a low thermal expansion ceramic material such as alumina or silica. The antireflection treatment may be matte black chromium plating, nickel plating treatment, or the like. In addition, ceramic coating treatment of black alumina or carbon may be used. By performing the antireflection treatment on the inner cylindrical surface of the transmission lens barrel 23 as described above, it is possible to prevent excess light (stray light) other than light directly entering the transmission lens 22 from the deep ultraviolet LED 21 from being reflected by the inner cylindrical surface and emitted from the transmission lens 22. That is, the transmission light can be transmitted at the predetermined transmission light viewing angle θs (transmission light visual field Ss), and the occurrence of the distance error of the LiDAR data can be prevented in the observation of the dToF method. That is, the reception light intensity P(R) can be observed with high accuracy.

The transmission lens barrel 23 may include a hood on the front side of the transmission lens 22. The inner cylindrical surface of the hood is also subjected to the same antireflection treatment as described above.

### <Drive Circuit 24>

Next, the drive circuit 24 will be described.

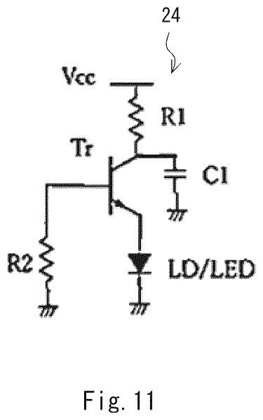

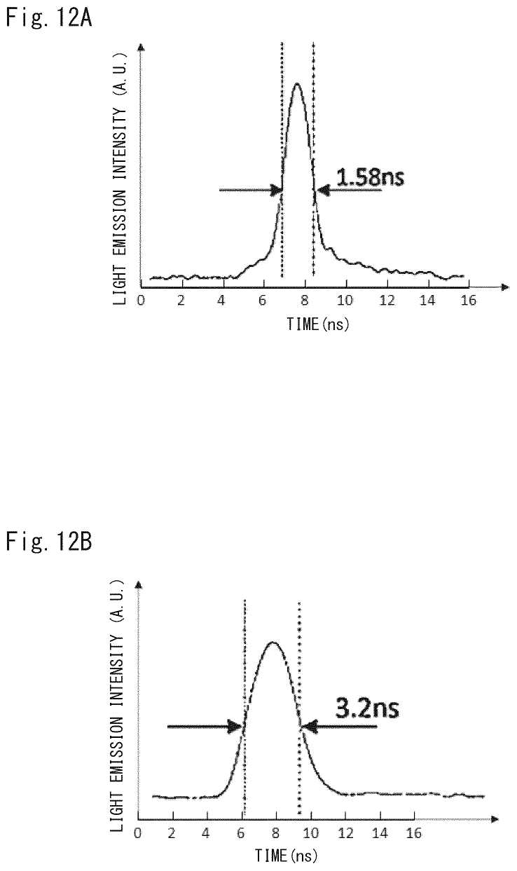

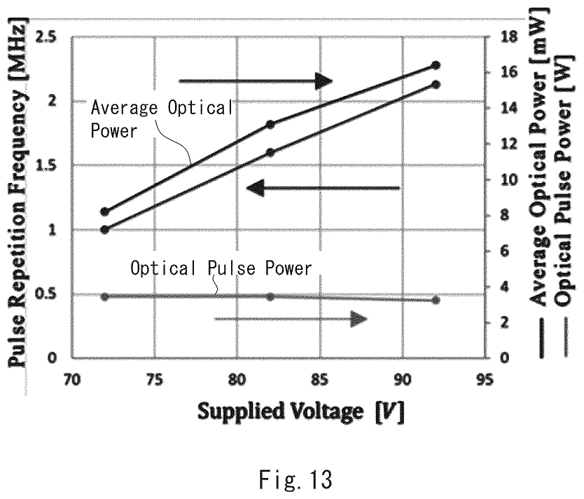

FIG. 11 shows an example of the drive circuit 24, and FIGS. 12A and 12B show examples of transmission characteristics of pulse light. FIG. 13 is a graph showing a relationship between a supply voltage (V) and a frequency (MHz). The drive circuit 24 shown in FIG. 11 is a drive circuit using avalanche breakdown of a transistor. In FIGS. 12A and 12B, the horizontal axis represents time (ns), and the vertical axis represents a relative value of emission intensity (A. U).

The drive circuit 24 is a drive circuit for realizing pulse light having a frequency of 1 MHz to 10 MHz and a pulse width of 1 ns to 10 ns as transmission light. The control analysis unit 40 controls the deep ultraviolet LED 21 via the drive circuit 24 to emit transmission light (pulse light) having a frequency of 1 MHz and a pulse width of 9.6 ns.

The pulse width of the transmission light is adjusted by selecting the capacitance of the capacitor C1 of the drive circuit 24. For example, by setting the capacitance of the capacitor C1 to a small capacitance or a large capacitance, the emission pulse width (full width at half maximum) can be adjusted to 1.58 ns (see FIG. 12A) or 3.2 ns (see FIG. 12B).

The frequency (emission light cycle) of the transmission light can be adjusted (controlled) by fixing a value of a resistor R1 of the drive circuit and selecting an applied voltage between Vcc and the ground voltage. For example, as shown in FIG. 13, by setting the applied voltage to 72 V to 92 V, the slow recharge time can be adjusted, and the emission light cycle can be controlled to 1 MHz to 2.1 MHz. The light intensity of the pulse light in this case can be substantially constant because the avalanche breakdown voltage of the transistor is constant. As another method, the frequency of the transmission light can be selected by setting the voltage between Vcc and the ground voltage constant and selecting a value of the resistor R1.

A distance resolution (spatial resolution) is determined by a pulse width of transmission light (pulse light). For example, when the pulse width is 1 ns, the distance resolution (spatial resolution) is 0.15 m (light speed c (m/s)·pulse width τ (s)/2). As a result, a detailed distribution of the observation target object Ob (for example, particles in space) can be observed. When the pulse width is 10 ns, the distance resolution (spatial resolution) is 1.5 m. As a result, the distribution of the observation target object Ob (for example, coarse particles in space) can be observed.

The observation distance (measurement distance) is determined by the frequency of the transmission light (pulse light). For example, in a case of a frequency of 1 MHz (cycle of 1 μs= 1/1,000,000 (/s)), the observation maximum distance is 150 m (light speed c (m/s)·cycle f(s)/2). In addition, in the case of a frequency of 10 MHz, the observation maximum distance is 15 m. That is, the observation distance (measurement distance) can be set within a range in which the return light (reception light) of the previous transmission light does not overlap the emission time of the next transmission light.

Thus, the pulse width and the frequency of the transmission light can be easily adjusted by selecting a capacitor C1 and the resistor R1 of the drive circuit 24 and selecting the voltage between Vcc and the ground voltage. Specifically, by preparing and selecting capacitors C1a, C1b, C1c, . . . having different capacitances as the capacitors C1 and resistors R1a, R1b, R1c, . . . having different resistance values as the resistors R1, the pulse width or the frequency of the transmission light can be adjusted in a wide range.

### <Reception Unit 30>

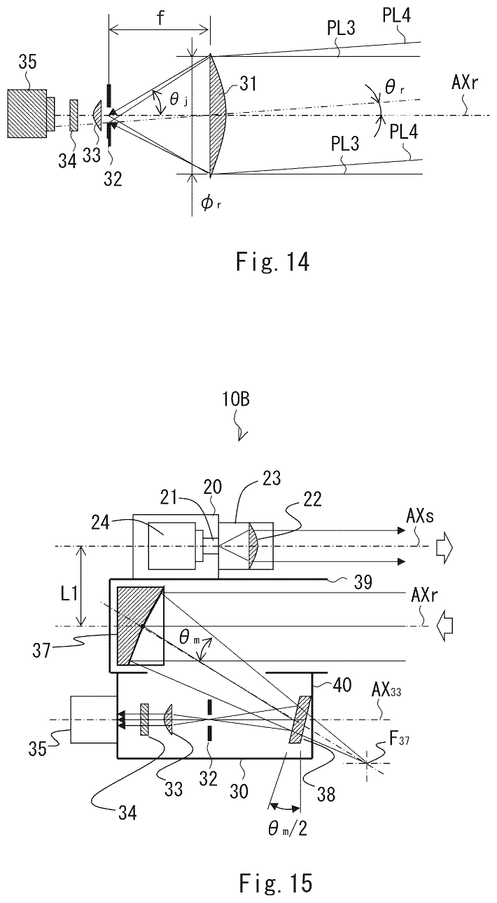

As shown in FIGS. 8 and 14, the reception unit 30 includes a first reception lens 31 (an example of a reception optical system of the present disclosure), a field stop 32, a second reception lens 33, a reception filter 34, and a light receiving element 35. In FIG. 8, the reference numeral 36 denotes a reception lens barrel. FIG. 14 is a schematic diagram of the reception unit 30 extracted from FIG. 8.

The first reception lens 31 is, for example, a condensing lens that is rotationally symmetric with respect to the optical axis AXr of the reception unit 30. Similarly to the transmission lens 22, the first reception lens 31 (and the second reception lens 33) is (are) made of quartz glass. The first reception lens 31 collects reflected light PL3 and PL4 (reflected pulse light) reflected by the observation target object Ob and returning into the reception light visual field Sr among pieces of the transmission light (pulse light).

The first reception lens diameter φr (the aperture of the reception lens barrel 36) is larger than the diameter φs of the transmission lens 22 (the aperture of the transmission lens barrel 23) in order to improve the uptake amount of the reflected light PL3 and PL4 (reflected pulse light) reflected by the observation target object Ob and returning into the reception light visual field Sr. As a result, it is possible to receive the reflected light PL3 and PL4 (reflected pulse light) reflected by the observation target object Ob existing in the intended region and returning into the reception light visual field Sr.

Specifications of the first reception lens 31 are as described in the following table.

TABLE 3

| | |
|---|---|
| Lens diameter φs | 100 mm |
| Reception light viewing angle θr | 3 mrad (0.173°) to 5 mrad |
| | (0.286°) |
| Focal length f | Optional |
| Convergence angle θj | Optional |

The reception light viewing angle θr is set to be narrow (3 mrad (0.173°) to 5 mrad (0.286°)) so that an intended region (a plane orthogonal to the optical axis) can be observed.

In a case where the lens diameter φr of the first reception lens 31 is 100 mm and the focal length f is 200 mm, a convergence angle θj (see FIG. 14) of the first reception lens 31 is about 14 degrees. This can be calculated from the equation tan (θj)=(φr/2)/f. On the other hand, in a case where the reception light viewing angle θr (see FIG. 14) is 3 mrad (0.173°) and the focal length f is 200 mm, a visual field image size Er is about 0.3 mm square. This can be calculated from the equation tan (θr)=(Er/2)/f.

Similarly to the transmission lens barrel 23, the reception lens barrel 36 is made of aluminum, and has an inner cylinder surface subjected to antireflection treatment. As a result, it is possible to absorb light incident on the reception lens 31 at a viewing angle other than the predetermined reception light viewing angle θr and prevent the light from reaching the light receiving element 35.

The field stop 32 is a light shielding stop that controls (narrows or widens) the reception light visual field Sr.

By providing the field stop 32 at the focal point (focal plane) of the first reception lens 31, the observation range (reception light visual field Sr) can be defined. For example, in the case of observing the wide reception light visual field Sr, the field stop 32 is opened, and conversely, in the case of observing only the narrow reception light visual field Sr, the field stop 32 is narrowed. As a result, the reception light visual field Sr can be adjusted.

Furthermore, in a case where the reception light viewing angle θr is constant, the visual field image of the focal plane can be reduced by shortening the focal length f of the first reception lens 31. Conversely, the visual field image of the focal plane can be increased by increasing the focal length f of the first reception lens 31.

The second reception lens 33 adjusts the visual field image of the focal plane to the size of the light receiving surface of the light receiving element 35. Note that the second reception lens 33 may be omitted in a case where it is unnecessary.

The reception filter 34 is a bandpass filter configured to transmit only reflected light (reflected pulse light) reflected by the observation target object Ob and returning into the reception light visual field Sr. In the first configuration example, a bandpass filter of 266 nm±5 nm (corresponding to the full width at half maximum of the deep ultraviolet LED 21) is used. By providing the reception filter 34, an S/N ratio of the signal (pulse electrical signal) corresponding to the reflected light (reflected pulse light) received by the reception unit 30, which is output by the reception unit 30 (light receiving element 35), is improved.

The light receiving element 35 is an ultraviolet photomultiplier tube (PMT) for photon counting. The PMT which is the light receiving element 35 of the first configuration example includes a high-voltage circuit necessary for an operation of the PMT and a preamplifier circuit which amplifies a pulse electrical signal photoelectrically converted by the PMT. Note that the light receiving element 35 may be a photoelectric conversion element for photon counting other than the PMT. The light receiving element 35 outputs a signal (pulse electrical signal) corresponding to the reflected light (reflected pulse light) received by the light receiving element 35.

The reception light visual field Sr is a circle obtained by adding the aperture φr of the first reception lens 31 to a circle drawn by the reception light viewing angle θr centered on the optical axis A Xr of the reception unit 30. In other words, the reception light visual field Sr is a circle of which the radius is a sum of the radius of the circle of the reception light viewing angle θr and the radius of the aperture φr of the first reception lens 31.

An optical axis AXs of the transmission unit 20 and an optical axis AXr of the reception unit 30 are disposed in a state of being separated from each other and being parallel to each other. A distance L1 (see FIG. 8) between the optical axis AXs of the transmission unit 20 and the optical axis AXr of the reception unit 30 is, for example, 85 mm. The distance L1 is preferably close to an aperture addition half value distance, which is a half value of the sum of the aperture of the transmission lens 22 of the transmission unit 20 and the aperture of the reception lens 31 of the reception unit 30, because the superimposition start distance r1 between the transmission light visual field Ss and the reception light visual field Sr is shortened. In general, the distance L1 is preferably about 1.05 to 1.1 times the aperture addition half value distance.

Also in the first configuration example, the transmission light visual field Ss and the reception light visual field Sr overlap each other (see the hatched region HT in FIG. 2 and the superimposed light visual field Sc in each cross-sectional view).

As a result, also in the first configuration example, since the reflected light (reflected pulse light) reflected by the observation target object Ob and returning into the reception light visual field Sr can be received, the observation target object Ob existing at a short distance (beyond the first position P1) can be observed. That is, observation data (LiDAR data) can be generated with high accuracy.

### <Second Configuration Example of Observation Apparatus 10>

Next, a specific second configuration example of the observation apparatus 10 will be described. Hereinafter, the observation apparatus 10 of the second configuration example will be referred to as an observation apparatus 10B.

FIG. 15 is a schematic configuration diagram of the observation apparatus 10B.

The observation apparatus 10B is an observation apparatus (LiDAR apparatus) including a transmission unit 20 of a refractive system and a reception unit 30 of a reflective system.

As shown in FIG. 15, the observation apparatus 10B includes a transmission unit 20, a reception unit 30, and a control analysis unit 40 (not shown in FIG. 15). The optical axis AXs of the transmission unit 20 and the optical axis AXr of the reception unit are disposed to be separated from and parallel to each other.

### <Transmission Unit 20>

The transmission unit 20 includes a semiconductor light emitting element 21 and a transmission lens 22 (an example of a transmission optical system of the present disclosure).

The transmission unit 20 differs from the transmitter 20 of the first configuration example in specifications of the transmission lens 22. Specifications of the transmission lens 22 are as described in the following table.

TABLE 4

| Lens diameter φs | Φ25.4 mm (effective diameter |
|---|---|
| | φ25 mm) |
| Transmission light viewing angle θs | 25.99 mrad (≈26 mrad) |
| Focal length f | 20 mm |
| Uptake angle θi | 30° |

That is, the transmission lens 22 has a shorter focal length and a wider transmission light viewing angle θs than those of the transmission lens 22 of the first configuration example. As a result, even if the reception light aperture is increased, the transmission light visual field Ss can be overlapped with and included in the reception light visual field Sr at a short distance. Since the deep ultraviolet LED of 1.04 mm square is used, the transmission light viewing angle θs is 1.489° (25.99 mrad≈26 mrad). Other than that, the transmission unit 20 is similar to the transmission unit 20 of the first configuration example.

### <Reception Unit 30>

As shown in FIG. 15, the reception unit 30 is different from the reception unit 30 of the first configuration example in that a first reception mirror 37 and a second reception mirror 38 (an example of a reception optical system of the present disclosure) are provided instead of the first reception lens 31. Other than that, the reception unit 30 is similar to the reception unit 30 of the first configuration example. In FIG. 15, the reference numeral 39 denotes a reception main lens barrel, and the reference numeral 40 denotes a reception sub-lens barrel.

The first reception mirror 37 is a non-axial parabolic mirror (a peripheral portion of the parabolic mirror), and has a focal point F₃₇ outside the reception main lens barrel 39.

The second reception mirror 38 is disposed between the first reception mirror 37 and the focal point F₃₇ of the first reception mirror 37. The second reception mirror 38 is an example of a return mirror of the present disclosure.

Reflected light (reflected pulse light) reflected by the observation target object Ob and returning into the reception light visual field Sr is reflected by the first reception mirror 37 to be collected toward the focal point F₃₇, further reflected by the second reception mirror 38, and guided to the light receiving element 35. In this manner, in the observation apparatus 10B, the transmission unit 20 and the reception unit 30 are separated. In addition, the second reception mirror 38 and the light receiving element 35 are provided outside an opening (an opening through which reception light is taken in) of the reception main lens barrel 39 of the reception unit 30. This prevents the reception light visual field Sr from being shielded in the observation distance region beyond the first position P1.

In the second configuration example, since an optical axis AXr (the center line of the first reception mirror 37) of the reception unit 30 and an optical axis AX₃₃ (the center line of the light receiving element 35) of the second reception lens 33 are disposed in parallel, the second reception mirror 38 is inclined by ½ of an angle θm formed by the reflected light (light beam) reflected by the center of the first reception mirror 37 and the optical axis AX₃₃ of the second reception lens 33.

Similarly to the first configuration example, the reception light viewing angle θr is 3 mrad or 5 mrad.

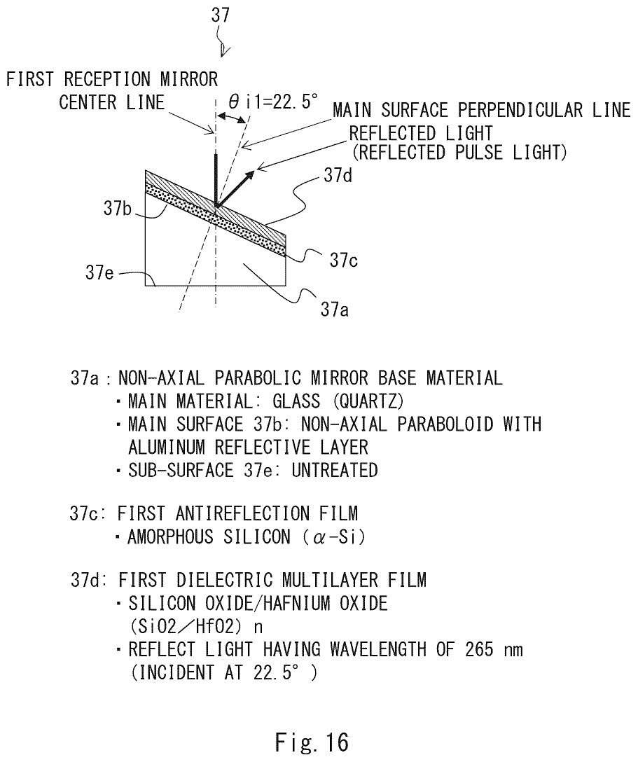

FIG. 16 is a cross-sectional view of the first reception mirror 37.

The first reception mirror 37 includes a non-axial parabolic mirror base material 37a having an aluminum-coated non-axial paraboloid as a main surface, an amorphous silicon (α-Si) first antireflection film 37c (an example of an antireflection member of the present disclosure) that is provided on the aluminum-coated surface of a main surface 37b and absorbs light in a near-ultraviolet to visible light band, and a first dielectric multilayer film 37d that is provided on the first antireflection film 37c and reflects light having a wavelength of 265 nm (incident at 22.5°), and is a mirror that reflects and collects light incident in parallel with an optical axis of the parabolic mirror of the original shape to a focal point F₃₇ of the parabolic mirror of the original shape.

Note that the various films and the disposition of the first reception mirror 37 may have the same configuration as that of the second reception mirror 38 that will be described later.

The non-axial parabolic mirror is a mirror in which an outer peripheral portion of the parabolic mirror is hollowed out, and a focal point (a focal point of a mirror of the original shape) is located outside the mirror.

The first antireflection film 37c is made of amorphous silicon (α-Si), titanium carbon nitride (TiCN), or diamond-like carbon (DLC), and is a layer that absorbs light in a near-ultraviolet to visible light band. In the second configuration example, the first antireflection film 37c has a function of absorbing light in a near-ultraviolet to visible light band transmitted through the first dielectric multilayer film 37d.

The first dielectric multilayer film 37d is a film in which thin films of silicon oxide (SiO₂) and hafnium oxide (hfO₂) are laminated in multiple layers, has a high reflectance (90% or more) with respect to light of deep ultraviolet 265 nm (incident angle) 22.5°, and transmits light in a near-ultraviolet to visible light band.

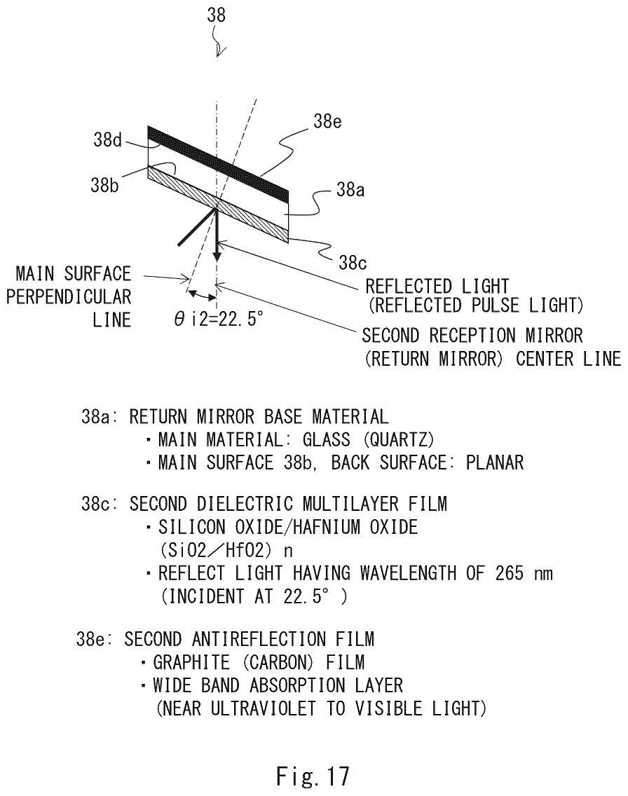

FIG. 17 is a cross-sectional view of the second reception mirror 38.

As shown in FIG. 17, the second reception mirror 38 includes a base material 38a (return mirror base material) of a flat plate, a second dielectric multilayer film 38c that reflects light having a wavelength of 265 nm (incident at) 22.5° on a main surface 38b, and a second antireflection film 38e (an example of an antireflection member of the present disclosure) of graphite (carbon) that absorbs light in a near-ultraviolet to visible light band on a sub surface 38d (back surface), and symmetrically reflects light incident on the main surface 38b.

The second antireflection film 38e is made of graphite, carbon, diamond-like carbon, or the like, and absorbs light transmitted through the second dielectric multilayer film 38c. In other words, light serving as a noise component other than observation purpose light (transmission light) is absorbed.

The second dielectric multilayer film 38c has the same configuration as that of the first dielectric multilayer film 37d.

Next, the reflectance of each reception mirror will be described.

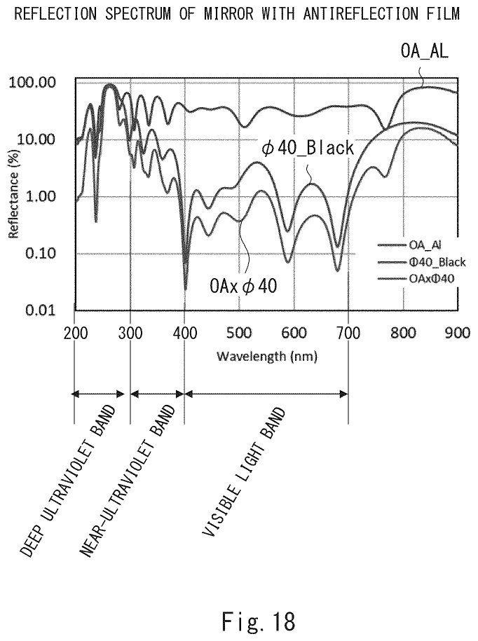

FIG. 18 shows a reflection spectrum of reflected light by each reception mirror.

Reflectance of 22.5° incident light was measured with respect to reflection surfaces of the first reception mirror 37 (non-axial parabolic mirror) and the second reception mirror 38 (return mirror). In FIG. 13, the horizontal axis represents a wavelength, and the vertical axis represents reflectance (%).

In FIG. 18, “OA_A1” represents a reflection spectrum of the first reception mirror 37 in which the first antireflection film 37c and the first dielectric multi-layer film 37d are provided on the main surface 37b of the non-axial parabolic mirror base material 37a with an aluminum layer. The configuration of the first reception mirror 37 is as described in the following table.

TABLE 5

| | |
|---|---|
| Configuration | Base material (glass/aluminum layer)/first |
| | antireflection film/first dielectric multilayer |
| | film layer |
| First antireflection | Amorphous silicon (α-Si) |
| film | |
| First dielectric | {Silicon oxide (SiO2)/hafnium oxide (HfO2)}n |
| multilayer film | |
| Deposition | Sputtering method |

In FIG. 18, “Φ40_Black” represents a reflection spectrum of the second reception mirror 38 in which the second dielectric multilayer film 38c is provided on the main surface 38b of the return mirror base material 38a and the second antireflection film 38e is provided on the sub-surface 38d (back surface).

The configuration of the second reception mirror 38 is as described in the following table.

TABLE 6

| | |
|---|---|
| Configuration | Second dielectric multilayer film/substrate |
| | (glass)/second antireflection film |
| Second | Graphite film |
| antireflection film | |
| Second dielectric | {Silicon oxide (SiO2)/hafnium oxide (HfO2)}n |
| multilayer film | |
| Deposition | Sputtering method |

In FIG. 18, “OAxφ40” represents a product (total reflectance spectrum) of the reflectances of the first reception mirror 37 and the second reception mirror 38.

Next, functions, operations, and effects of the antireflection film will be described.

The reflectance in the deep ultraviolet band, particularly the reflectance product of the transmission light wavelength at 265 nm is as high as 90% or more.

On the other hand, the reflectance product of light in the near-ultraviolet band of 300 nm to 400 nm is reduced to 1/10 or less, and the reflectance in the visible light band of 400 nm to 700 nm is reduced to 1/100 or less.

As described above, by providing the antireflection film layer on the first reception mirror 37 and the second reception mirror 38, noise light can be removed before being incident on the light receiving element 35. This makes it possible to suppress the influence of sunlight particularly in daytime observation. The light receiving element 35 for photon counting has high reception sensitivity. Therefore, light having a wavelength other than the light receiving target wavelength (wavelength of 265 nm) can be removed before reaching the light receiving element 35. As a result, noise can be suppressed, and highly accurate observation can be performed.

Next, an observation apparatus 10C that determines an atmospheric state will be described.

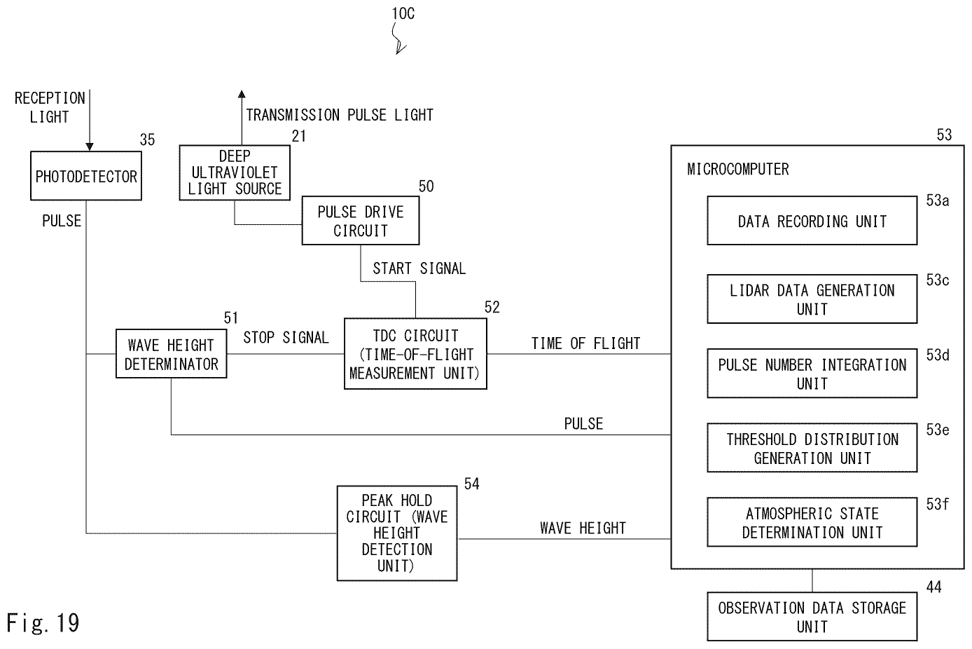

FIG. 19 is a block diagram showing a main configuration of the observation apparatus 10C. FIG. 19 shows a configuration of the observation apparatus 10C in which a pulse drive circuit 50, a wave height determinator 51, a TDC circuit 52 (time-of-flight measurement unit), a microcomputer 53, and a peak hold circuit 54 (wave height detection unit) are added to the observation apparatus 10. Hereinafter, the same constituents as those of the observation apparatus 10 are denoted by the same reference numerals, and description thereof will be omitted.

As shown in FIG. 19, the observation apparatus 10C includes a deep ultraviolet light source 21 (deep ultraviolet LED 21), a pulse drive circuit 50, a photodetector 35 (light receiving element 35), a wave height determinator 51, a TDC circuit 52, a microcomputer 53, and a peak hold circuit 54 (wave height detection unit). The microcomputer 53 functions as a data recording unit 53a, a LiDAR data generation unit 53c, a pulse number integration unit 53d, a threshold distribution generation unit 53e, and an atmospheric state determination unit 53f by executing a predetermined program read from a storage unit (for example, a ROM) into a memory (for example, a RAM). Some or all of the units may be realized by hardware.

The deep ultraviolet light source 21 transmits pulse light (for example, a Lambertian distribution having a peak wavelength of 265 nm and a half value angle of about) 120° having a wavelength belonging to the ultraviolet region of the solar blind band under the control of the pulse drive circuit 50. The frequency of the pulse light is, for example, 1 MHz. The pulse drive circuit 50 controls the deep ultraviolet light source 21 and transmits a start signal to the TDC circuit 52.

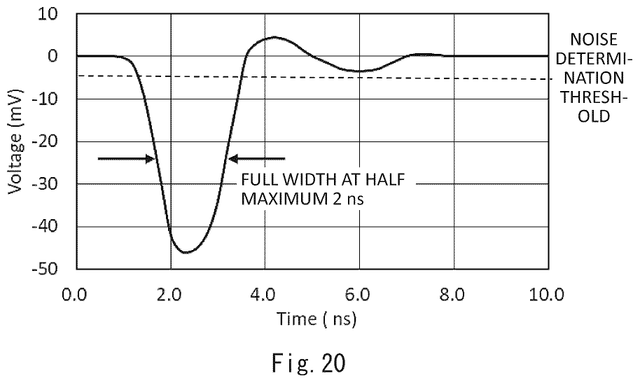

The photodetector 35 receives reflected light (photons) of the pulse light transmitted from the deep ultraviolet light source 21, reflected by the observation target object, and returned. The photodetector 35 outputs a pulse (voltage pulse signal) of which a wave height changes (the wave height increases in proportion to the number of photons) according to the number of photons of the reflected light of the pulse light received within a response period (or an interval less than the resolution of the photodetector 35), for example, 2 ns. FIG. 20 shows an example of typical pulses output from the photodetector 35 and noise determination thresholds. The full width at half maximum of the pulse shown in FIG. 20 is approximately 2 ns, and the peak voltage is approximately 50 mV. The pulse output from the photodetector 35 is transmitted to the wave height determinator 51 and the peak hold circuit 54 (wave height detection unit).

The photodetector 35 may be any detector as long as it outputs a pulse of which a wave height changes according to the number of photons of the reflected light of the pulse light received within the response period, and may be, for example, a photomultiplier tube or a multi-pixel photon counter (MPPC). The photomultiplier tube may be, for example, Hamamatsu Photonics K.K. “H10721P-113” that is highly sensitive to deep ultraviolet.

The wave height determinator 51 determines and outputs a pulse having a wave height equal to or more than the noise determination threshold among the pulses transmitted from the photodetector 35. The wave height equal to or more than the noise determination threshold is a wave height having an absolute value equal to or greater than an absolute value of the noise determination threshold. For example, in a case where the noise determination threshold is set to about −5 mV, the wave height determinator 51 outputs only a pulse of which a wave height is equal to or more than the noise determination threshold (a pulse that becomes more negative than the threshold of −5 mV). The pulse that becomes more negative than the noise determination threshold of −5 mV is a pulse of −5 mV or less, for example, pulses of −6 mV, −10 mV, and −20 mV. As a result, noise less than the noise determination threshold is removed, and only a pulse equal to or more than the noise determination threshold passes through the wave height determinator 51. The pulse output from the wave height determinator 51 is transmitted as a stop signal to the TDC circuit 52 (time-of-flight measurement unit). The pulse output from the wave height determinator 51 is transmitted to the microcomputer 53.

Every time the wave height determinator 51 outputs a pulse, the TDC circuit 52 (time-of-flight measurement unit) measures the time of flight according to the pulse output as the stop signal by the wave height determinator 51. Specifically, the TDC circuit 52 (time-of-flight measurement unit) measures a time difference between the start signal and the stop signal, and outputs the time difference as a time of flight (ToF). This time of flight can be converted into a distance. The time of flight output from the TDC circuit 52 is transmitted to the microcomputer 53.

Every time the photodetector 35 outputs a pulse, the peak hold circuit 54 (wave height detection unit) detects a wave height (peak value) of the pulse output from the photodetector 35. The wave height detected by the peak hold circuit 54 is transmitted to the microcomputer 53.

The data recording unit 53a records the wave height detected by the peak hold circuit 54 and the time of flight measured by the TDC circuit 52 in association with each other in the storage unit (the observation data storage unit 44 or the like) for each pulse output from the wave height determinator 51.

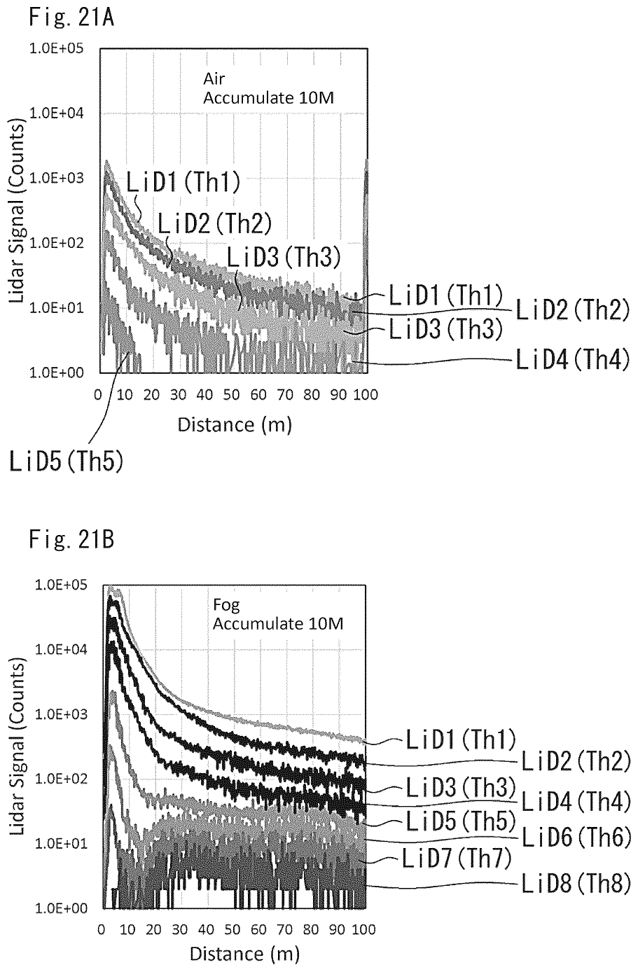

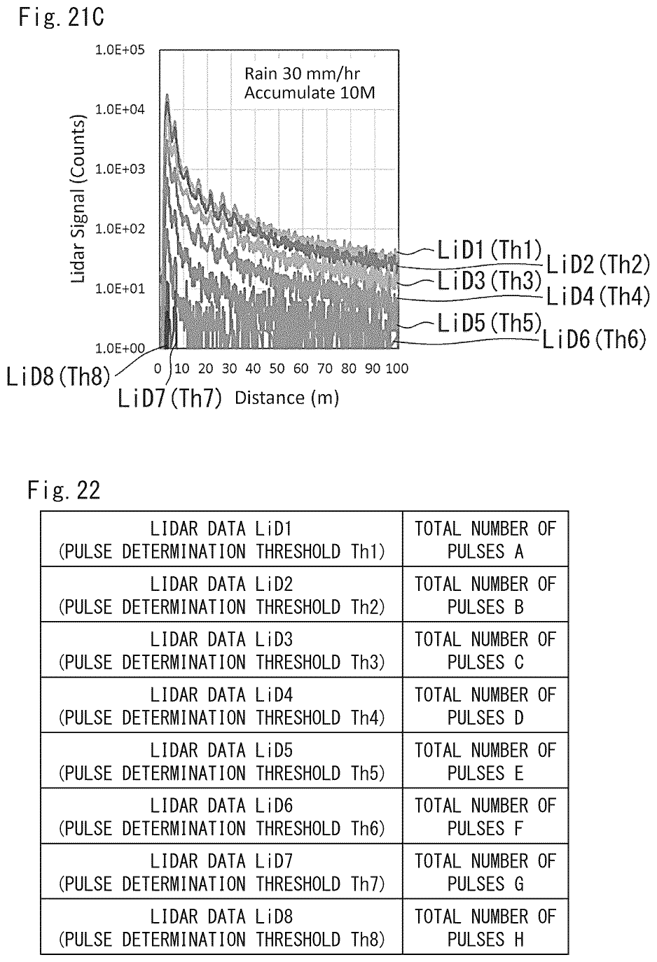

On the basis of the wave height and the time of flight recorded for each pulse output from the wave height determinator 51, the LiDAR data generation unit 53c generates LiDAR data in which the number of pulses having a wave height equal to or more than the pulse determination threshold is aggregated for each distance for each of different pulse determination thresholds after the end of the measurement period. The measurement period is, for example, 1 second. The different pulse determination thresholds are a plurality of mutually different thresholds, for example, Th1 (=−10), Th2 (=−20), Th3 (=−30), Th4 (=−40), Th5 (=−50), Th6 (=−60), Th7 (=−70), and Th8 (=−80) shown in FIG. 21.

FIG. 21A shows LiDAR data obtained by measuring in a case where an observation target is fine weather in which neither fog nor rain is generated, and aggregating the number of pulses having a wave height equal to or more than the pulse determination threshold for each distance for each of different pulse determination thresholds. Similarly, FIG. 21B shows LiDAR data measured and aggregated in a case where an observation target is foggy weather with visibility of about 30 m, and FIG. 21C shows LiDAR data measured and aggregated in a case where an observation target is rainy weather with a rainfall of 30 mm/hr. The LiDAR data is data in a histogram format in which the horizontal axis represents a distance (or a time of flight) and the vertical axis represents the number of photons (for example, see LiDAR data LiD1 to LiD8 shown in FIG. 21). The LiDAR data is stored in the observation data storage unit 44.

From the results of FIGS. 21A, 21B, and 21C, it can be seen that the number of pulses having a great peak value is large in rainy weather compared with fine weather, and the number of pulses having a great peak value is large in fog occurrence compared with fine weather or rainy weather. At the time of the occurrence of fog, since the density of particles (fog) is high, reflected photons at a certain particle and multiple reflected photons at a particle in the vicinity of the particle return to the detector almost simultaneously, it is considered that a pulse having a great peak value is detected compared with fine weather. In addition, in rainy weather, since particles (rain) are large with respect to the wavelength of deep ultraviolet light, a plurality of photons are simultaneously reflected and return to the photodetector, and thus it is considered that a pulse having a great peak value is detected compared with fine weather. In the atmosphere, since the particles are small with respect to the wavelength of deep ultraviolet light and the concentration of the particles is low, it is considered that the overall reflection signal is weak and a pulse having a great peak value is not detected.

The pulse number integration unit 53d integrates the total number of pulses within a predetermined distance range in the LiDAR data for each piece of LiDAR data (or a pulse determination threshold) (see FIG. 22). FIG. 22 shows an example in which the total number of pulses within a predetermined distance range (a distance range desired to be observed) in the LiDAR data is integrated for each piece of LiDAR data. For example, in a case where the distance range of the LiDAR data is 0 to 100 m, the predetermined distance range is set to 3 to 90 m.

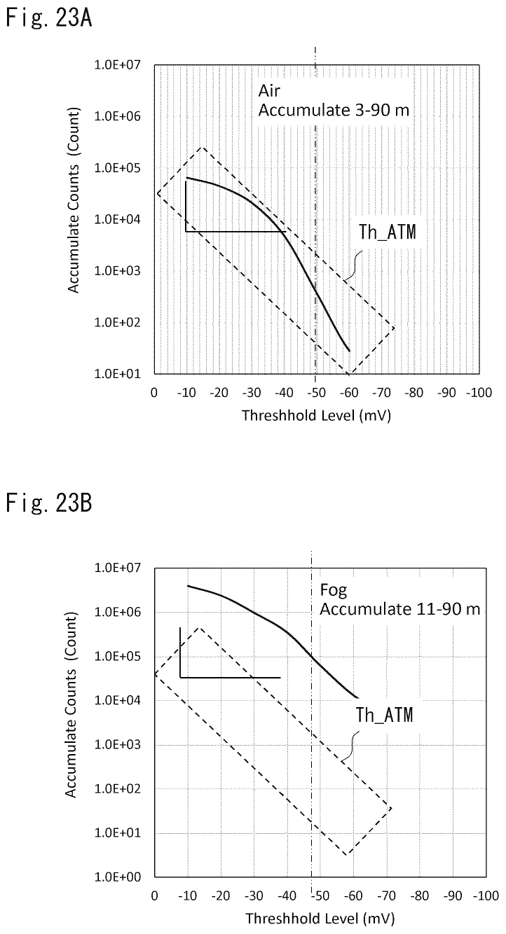

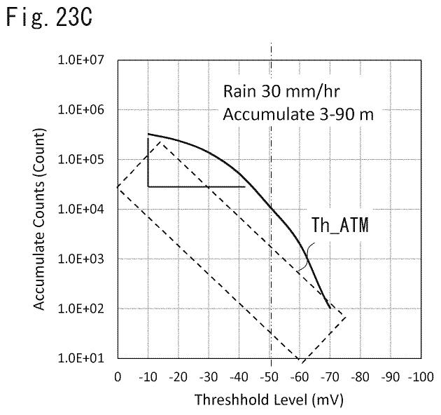

The threshold distribution generation unit 53e generates a threshold distribution obtained by aggregating the total number of pulses integrated for each piece of LiDAR data for each pulse determination threshold (see FIG. 23). FIG. 23 is a graph in which the threshold distribution is plotted on a graph in which the horizontal axis represents a pulse determination threshold and the vertical axis represents the total number of pulses. FIG. 23A shows the total number of pulses obtained within a distance range of 3 to 90 m for each pulse determination threshold from the LiDAR data in FIG. 21A. FIG. 23B shows the total number of pulses obtained within the distance range of 3 to 90 m for each pulse determination threshold from the LiDAR data in FIG. 21B. FIG. 23C shows the total number of pulses obtained within the distance range of 3 to 90 m for each pulse determination threshold from the LiDAR data in FIG. 21C. That is, FIG. 23A shows a threshold distribution in a case where the observation target is fine weather, FIG. 23B shows a threshold distribution in a case where the observation target is foggy weather, and FIG. 23C shows a threshold distribution in a case where the observation target is rainy weather. Referring to FIGS. 23A to 23C, it can be seen that the total number of pulses tends to gradually decrease as the pulse determination threshold increases in any of fine weather, foggy weather, and rainy weather as an observation target.

The atmospheric state determination unit 53f determines an atmospheric state by comparing the threshold distribution with the reference threshold distribution. For example, it can be determined that the atmospheric state is fine weather, rainy weather, or foggy weather.

According to the study of the present inventors, as shown in FIGS. 23A to 23C, it has been found that there is a relationship of total number of pulses in foggy weather threshold distribution (see FIG. 23B)>total number of pulses in rainy weather threshold distribution (see FIG. 23C)>total number of pulses in fine weather threshold distribution (see FIG. 23A).

This can be described as follows. That is, in the case of fine weather, since the diameter of particles (molecules and the like) in the atmosphere is very small compared with the wavelength of the transmission pulse light, Rayleigh scattering occurs when the transmission pulse light is incident on the particles in the atmosphere. Furthermore, since the density of particles in the atmosphere is also low, the number of reflected pulse light, that is, photons, returning to the photodetector 35 is the smallest.

On the other hand, in the case of foggy weather, since the wavelength of the transmission pulse light is equal to the diameter of the particles (fog droplets) in the atmosphere, Mie scattering occurs when the transmission pulse light is incident on the particles in the atmosphere. Furthermore, since the density of particles in the atmosphere is also high, the number of reflected pulse light, that is, photons, returning to the photodetector 35 is the largest.

In the case of rain, since the diameter of particles in the atmosphere (rain particles) is extremely larger than the wavelength of the transmission pulse light, geometric optical scattering occurs when the transmission pulse light is incident on the particles in the atmosphere. Furthermore, since the density of particles in the atmosphere is moderate, the number of reflected pulse light, that is, photons, returning to the photodetector 35 is also moderate. As a result, it is considered that there is a relationship of total number of pulses in foggy weather threshold distribution (see FIG. 23B)>total number of pulses in rainy weather threshold distribution (see FIG. 23C)>total number of pulses in fine weather threshold distribution (see FIG. 23A).

Therefore, the atmospheric state can be determined by setting an appropriate threshold as the reference threshold distribution and comparing the threshold distribution with the reference threshold distribution. The reference threshold distribution may be stored in the memory 12 and read. The reference threshold distribution can be set on the basis of a measurement result of a specified atmospheric state, and may be set to, for example, a threshold distribution in fine weather. For example, a threshold range Th_ATM indicated by a dotted rectangle in FIG. 23A is set as the threshold. The threshold distribution is compared with the threshold range Th_ATM, and when the threshold distribution falls within the threshold range Th_ATM, the atmospheric state is determined to be fine weather. On the other hand, when the threshold distribution is located above the threshold range Th_ATM and in a range close to the threshold range Th_ATM (see FIG. 23C), the atmospheric state is determined to be rainy weather. When the threshold distribution is located above the threshold range Th_ATM and in a range far from the threshold range Th_ATM (see FIG. 23B), the atmospheric state is determined to be foggy weather. Note that the reference threshold distribution is not limited to the threshold range Th_ATM, and may be a straight threshold or a curved threshold. Furthermore, a plurality of reference threshold distributions may be set on the basis of measurement results of a plurality of atmospheric states, and the atmospheric states can be determined with higher accuracy by setting a plurality of reference threshold distributions.

Next, an operation example of the observation apparatus 10C having the above configuration will be described.

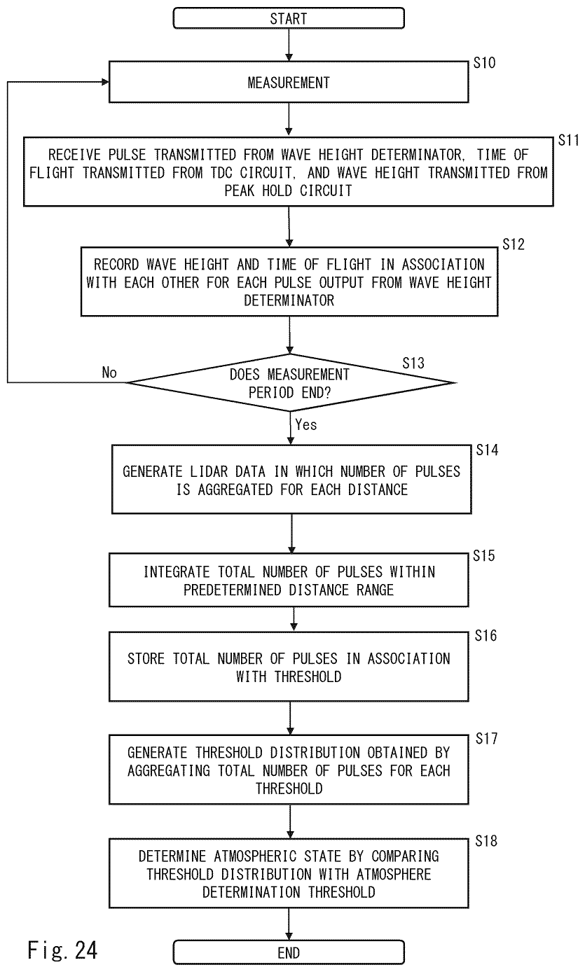

FIG. 24 is a flowchart of an operation example of the observation apparatus 10C.

The processing in FIG. 24 starts, for example, when an operator performs a predetermined operation on the observation apparatus 10C (for example, a measurement start switch is turned on). Although not shown, when the operator performs a predetermined operation on the observation apparatus 10C, the observation apparatus 10C (the microcomputer 53 or the like) executes a predetermined program read from the storage unit (for example, a ROM) into the memory (for example, a RAM) to execute each of the processes (steps S10 to S18) in FIG. 24.

First, measurement is performed (step S10). Specifically, the ultraviolet light source 21 transmits pulse light under the control of the pulse drive circuit 50, and the photodetector 35 outputs a pulse (voltage pulse signal) of which a wave height changes (the wave height increases in proportion to the number of photons) according to the number of photons of reflected light of the pulse light received within a response period (or an interval less than the resolution of the photodetector 35), for example, 2 ns. The pulse drive circuit 50 controls the deep ultraviolet light source 21 and transmits a start signal to the TDC circuit 52. The pulse output from the photodetector 35 is transmitted to the wave height determinator 51 and the peak hold circuit 54 (wave height detection unit). The wave height determinator 51 determines and outputs a pulse having a wave height equal to or more than the noise determination threshold among the pulses transmitted from the photodetector 35. The pulse output from the wave height determinator 51 is transmitted as a stop signal to the TDC circuit 52 (time-of-flight measurement unit). The pulse output from the wave height determinator 51 is also transmitted to the microcomputer 53. The TDC circuit 52 (time-of-flight measurement unit) measures a time difference between the start signal and the stop signal and outputs the time difference as a time of flight (ToF). The time of flight output from the TDC circuit 52 is transmitted to the microcomputer 53. On the other hand, every time the photodetector 35 outputs a pulse, the peak hold circuit 54 (wave height detection unit) receives the pulse transmitted from the peak hold circuit 54 and detects the wave height (peak value) of the pulse. The wave height detected by the peak hold circuit 54 is transmitted to the microcomputer 53. The process in step S10 is executed when the microcomputer 53 receives a trigger transmitted from the wave height determinator 51.

Next, the microcomputer 53 receives the pulse transmitted from the wave height determinator 51, the time of flight transmitted from the TDC circuit 52 (time-of-flight measurement unit), and the wave height transmitted from the peak hold circuit 54 (wave height detection unit) (step S11), and records the wave height detected by the peak hold circuit 54 and the time of flight measured by the TDC circuit 52 in the storage unit (the observation data storage unit 44 or the like) in association with each other for each pulse output from the wave height determinator 51 (the pulse transmitted from the wave height determinator 51) (step S12). This is realized by the data recording unit 53a.

The processes in steps S10 to S12 are repeatedly executed until the measurement period ends (step S13: Yes).

Next, after the measurement period ends (step S13: Yes), LiDAR data (here, LiD1 to LiD8 shown in FIG. 21) in which the number of pulses is aggregated for each distance is generated (step S14). This is realized by the LiDAR data generation unit 53c. Specifically, on the basis of the wave height and the time of flight (the wave height and the time of flight recorded in step S12) recorded for each pulse output from the wave height determinator 51, the LiDAR data generation unit 53c generates LiDAR data (LiD1 to LiD8 shown in FIG. 21, for example) in which the number of pulses having a wave height equal to or more than the pulse determination threshold is aggregated for each distance for each of different pulse determination thresholds (for example, Th1 to Th8 shown in FIG. 21) after the measurement period ends (step S13: Yes).

Next, the total number of pulses within a predetermined distance range is integrated (step S15). This is realized by the pulse number integration unit 53d. Here, the pulse number integration unit 53d integrates the total number of pulses within the predetermined distance range in the LiDAR data for each piece of LiDAR data (pulse determination threshold) (see FIG. 22). As a result, the total number of pulses A within a predetermined distance range (for example, within 3 to 90 m) in the LiDAR data LiD1, the total number of pulses B within a predetermined distance range (for example, within 3 to 90 m) in the LiDAR data LiD2, the total number of pulses C within a predetermined distance range (for example, within 3 to 90 m) in the LiDAR data LiD3, and the total number of pulses D within a predetermined distance range (for example, within 3 to 90 m) in the LiDAR data LiD4 are integrated. Similarly, the total number of pulses E within a predetermined distance range (for example, within 3 to 90 m) in the LiDAR data LiD5, the total number of pulses F within a predetermined distance range (for example, within 3 to 90 m) in the LiDAR data LiD6, the total number of pulses G within a predetermined distance range (for example, within 3 to 90 m) in the LiDAR data LiD7, and the total number of pulses H within a predetermined distance range (for example, within 3 to 90 m) in the LiDAR data LiD8 are integrated. As shown in FIG. 22, the total number of pulses A, B, C, D, E, F, G, and His stored in the storage unit (not shown) in association with the LiDAR data LiD1 to LiD8 (pulse determination thresholds Th1 to Th8) (step S16).

Next, a threshold distribution in which the total number of pulses is aggregated for each pulse determination threshold is generated (step S17). This is realized by the threshold distribution generation unit 53e. On the basis of the total number of pulses A, B, C, D, E, F, G, and H and the pulse determination thresholds Th1 to Th8 associated with the total number of pulses A, B, C, D, E, F, G, and H, the threshold distribution generation unit 53e generates a threshold distribution, for example, any one of the threshold distributions in FIGS. 23A to 23C obtained by aggregating the total number of pulses integrated for each piece of LiDAR data for each pulse determination threshold.

Next, the atmospheric state is determined by comparing the threshold distribution with the reference threshold distribution (step S18). This is realized by the atmospheric state determination unit 53f. The atmospheric state determination unit 53f determines an atmospheric state by comparing the threshold distribution with the reference threshold distribution. For example, as a result of the comparison, in a case where the threshold distribution generated in step S17 falls within the threshold range Th_ATM (see FIG. 23A), the atmospheric state is determined to be fine weather. On the other hand, in a case where the threshold distribution generated in step S17 is located above the threshold range Th_ATM and is in a range close to the threshold range Th_ATM (see FIG. 23C), the atmospheric state is determined to be rainy weather. In a case where the threshold distribution generated in step S17 is located above threshold range Th_ATM and is in a range far from the threshold range Th_ATM (see FIG. 23B), the atmospheric state is determined to be foggy weather.

As described above, according to the present embodiment, it is possible to provide the observation apparatus 10C and the atmospheric state determination method capable of determining the atmospheric state.

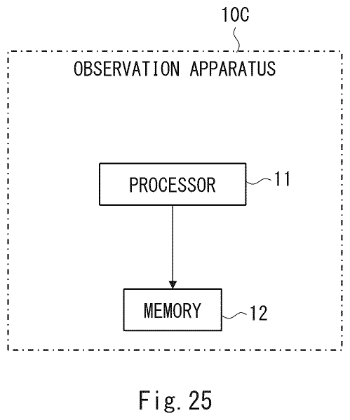

Next, a hardware configuration example of the observation apparatus 10 described in the above-described embodiment will be described. FIG. 25 is a diagram showing a hardware configuration example of the observation apparatus 10C according to the present disclosure.

Referring to FIG. 25, the observation apparatus 10C includes a processor 11 and a memory 12. The processor 11 reads software (computer program) from the memory 12 and executes the software, thereby performing the processing of the observation apparatus 10C described by using the flowcharts in the above-described embodiment. The processor 11 may be, for example, a microprocessor, a micro processing unit (MPU), or a central processing unit (CPU). The processor 11 may include a plurality of processors. The processor 11 may be built in the microcomputer 53.

The memory 12 is configured by a combination of a volatile memory and a nonvolatile memory. The memory 12 may include a storage located away from the processor 11. In this case, the processor 11 may access the memory 12 through an input/output (I/O) interface (not shown). The memory 12 may be built in the microcomputer 53.

In the example in FIG. 25, the memory 12 is used to store a software module group. The processor 11 can perform the processing of the observation apparatus 10C described in the above-described embodiments by reading the software module group from the memory 12 and executing the software module group.

As described with reference to FIG. 25, each of one or a plurality of processors included in the observation apparatus 10C executes one or a plurality of programs including an instruction group for causing a computer to perform the algorithm described with reference to the drawings.

In the above-described example, the program includes an instruction group (or software code) for causing the processor to perform one or more functions described in the embodiments. The program may be stored in a non-transitory computer-readable medium or a tangible storage medium. By way of example, and not limitation, computer-readable media or tangible storage media include a random-access memory (RAM), a read-only memory (ROM), a flash memory, a solid-state drive (SSD) or other memory technology, a CD-ROM, a digital versatile disc (DVD), Blu-ray® disc or other optical disk storages, a magnetic cassette, a magnetic tape, a magnetic disk storage, or other magnetic storage devices. The program may be transmitted on a transitory computer readable medium or a communication medium. By way of example, and not limitation, transitory computer-readable or communication media include electrical, optical, acoustic, or other forms of propagated signals.

Each numerical value described in each of the above embodiments is an example, and it is a matter of course that an appropriate numerical value different from this can be used.

Each of the above embodiments is merely an example in all respects. For example, the transmission unit 20 may be an optical system of a reflection system. Furthermore, each of the transmission unit 20 and/or the reception unit 30 may be a mixed optical system of a refraction system and a reflection system. In addition, although an observation target object in each of the above embodiments is the atmosphere containing fine particles, according to the present disclosure, a distance to an obstacle (a tree, a building, etc.) can be observed simultaneously with the atmosphere containing fine particles. That is, the present disclosure is not to be construed as being limited by the description of each of the above embodiments. The present disclosure can be implemented in various other forms without departing from the spirit or main characteristics thereof.

From the disclosure thus described, it will be obvious that the embodiments of the disclosure may be varied in many ways. Such variations are not to be regarded as a departure from the spirit and scope of the disclosure, and all such modifications as would be obvious to one skilled in the art are intended for inclusion within the scope of the following claims.

What is claimed is:

1. An observation apparatus comprising:
a deep ultraviolet light source configured to transmit pulse light having a wavelength belonging to an ultraviolet region of a solar blind band;
a photodetector configured to output a pulse of which a wave height changes according to the number of photons of reflected light of the pulse light received within a response period; and
a wave height determinator, a wave height detection unit, a time-of-flight measurement unit, a data recording unit, a LiDAR data generation unit, a pulse number integration unit, a threshold distribution generation unit, and an atmospheric state determination unit, wherein
the wave height determinator determines and outputs a pulse having a wave height equal to or more than a noise determination threshold among pulses output from the photodetector,
the wave height detection unit detects the wave height of the pulse output from the photodetector every time the photodetector outputs the pulse,
the time-of-flight measurement unit measures a time of flight every time the wave height determinator outputs the pulse,
the data recording unit records the wave height and the time of flight in association with each other for each pulse output from the wave height determinator,
the LiDAR data generation unit generates LiDAR data in which the number of pulses having a wave height equal to or more than the pulse determination threshold is aggregated for each distance for each of different pulse determination thresholds after end of the measurement period on the basis of the wave height and the time of flight recorded for each pulse output from the wave height determinator,
the pulse number integration unit integrates a total number of pulses within a predetermined distance range in the LiDAR data for each piece of the LiDAR data,
the threshold distribution generation unit generates a threshold distribution obtained by aggregating, for each threshold, the total number of pulses integrated for each piece of the LiDAR data, and
the atmospheric state determination unit determines an atmospheric state by comparing the threshold distribution with a reference threshold distribution.

2. The observation apparatus according to claim 1, wherein the atmospheric state determination unit determines whether the atmospheric state is fine weather, rainy weather, or foggy weather.

3. An atmospheric state determination method executed by an observation apparatus including a deep ultraviolet light source configured to transmit pulse light having a wavelength belonging to an ultraviolet region of a solar blind band and a photodetector configured to output a pulse of which a wave height changes according to the number of photons of reflected light of the pulse light received within a response period, the method comprising:
a wave height determination step of determining and outputting a pulse having a wave height equal to or more than a noise determination threshold among pulses output from the photodetector;
a wave height detection step of detecting the wave height of the pulse output from the photodetector every time the photodetector outputs the pulse;
a time of flight measurement step of measuring a time of flight every time a wave height determinator outputs the pulse;
a data recording step of recording the wave height and the time of flight in association with each other for each pulse output from the wave height determinator;
a LiDAR data generation step of generating LiDAR data in which the number of pulses having a wave height equal to or more than the pulse determination threshold is aggregated for each distance for each of different pulse determination thresholds after end of the measurement period on the basis of the wave height and the time of flight recorded for each pulse output from the wave height determinator;
a pulse number integration step of integrating a total number of pulses within a predetermined distance range in the LiDAR data for each piece of the LiDAR data;
a threshold distribution generation step of generating a threshold distribution obtained by aggregating, for each threshold, the total number of pulses integrated for each piece of the LiDAR data; and
an atmospheric state determination step of determining an atmospheric state by comparing the threshold distribution with a reference threshold distribution.

4. An observation apparatus comprising:
a deep ultraviolet light source configured to transmit pulse light having a wavelength belonging to an ultraviolet region of a solar blind band;
a photodetector configured to output a pulse of which a wave height changes according to the number of photons of reflected light of the pulse light received within a response period; and
a LiDAR data generation unit, a pulse number integration unit, a threshold distribution generation unit, and an atmospheric state determination unit, wherein
the LiDAR data generation unit generates LiDAR data in which the number of pulses having a wave height equal to or more than each pulse determination threshold is aggregated for each distance for each of a plurality of different pulse determination thresholds,
the pulse number integration unit integrates a total number of pulses within a predetermined distance range in the LiDAR data for each piece of LiDAR data,
the threshold distribution generation unit generates a threshold distribution obtained by aggregating, for each threshold, the total number of pulses integrated for each piece of the LiDAR data, and
the atmospheric state determination unit determines an atmospheric state by comparing the threshold distribution with a reference threshold distribution.
